(19) United States
(12) Patent Application Publication
(10) Pub. No.: US 2023/0058111 A1
(43) Pub. Date: Feb. 23, 2023

(54) SYSTEMS AND METHODS FOR PROVIDING LIVE SAMPLE MONITORING INFORMATION WITH PARALLEL IMAGING SYSTEMS

(71) Applicant: SamanTree Medical SA, Lausanne (CH)

(72) Inventors: Etienne Shaffer, Pailly (CH); Aurèle Timothée Horisberger, Crissier (CH); Andrey Naumenko, Chavannes-près-Renens (CH); Diego Joss, Renens (CH)

(21) Appl. No.: 17/880,404

(22) Filed: Aug. 3, 2022

Related U.S. Application Data
(60) Provisional application No. 63/232,120, filed on Aug. 11, 2021.
(60) Provisional application No. 63/229,258, filed on Aug. 4, 2021.

(51) Int. Cl. G02B 21/00

(52) U.S. Cl. CPC G02B 21/0024; G02B 21/0076; G02B 21/36

(57) ABSTRACT

In some embodiments, a method provides a live view mode without scanning a micro optical element array in which successive image(s) are generated, and optionally displayed, that comprise image pixels that represent sample light received from micro optical elements in an array for different, spatially distinct locations in a sample. Images can be of a useful size and resolution to obtain information indicative of a real time sample state. A full image acquisition by scanning a micro optical element array may be initiated when a sample has sufficiently (self-) stabilized. In some embodiments, a method provides images including a stabilization index without scanning a micro optical element array. A stabilization index that represents an empirically derived quantitative assessment of a degree of stabilization may be determined (e.g., calculated) for sample light received from for one or more micro optical elements each represented by one or more image pixels in an image.

### PRIORITY APPLICATIONS

This application claims the benefit of U.S. Provisional Patent Application No. 63/229,258, filed on Aug. 4, 2021, and U.S. Provisional Patent Application No. 63/232,120, filed on Aug. 11, 2021, the disclosure of each of which is hereby incorporated by reference herein in its entirety.

### TECHNICAL FIELD

This disclosure relates generally to systems and methods that use parallel imaging systems to providing live sample monitoring information to a user, for example regarding sample positioning, motion, and/or stabilization.

### BACKGROUND

Conventionally, tissue resected during a surgical procedure is assessed postoperatively with a pathological assessment performed once the tissue has been fixed. Such a process provides a high quality assessment but significant time is required to fix the tissue and obtain the pathological assessment. Therefore, important information about the sample cannot be known until long after the surgical procedure has completed. Recently, parallel imaging systems capable of imaging freshly resected tissue samples have been developed. Examples of such imaging systems are disclosed in U.S. Pat. Nos. 10,094,784 and 10,539,776, each of which are incorporated by reference herein in their entirety. Even with parallel imaging systems that can quickly image tissue, freshly resected tissue can be difficult to image because it is not fixed and therefore is prone to moving (e.g., relaxing) even over short timescales. One option for dealing with such sample motion has been to simply wait for a period of time before imaging to allow the sample to equilibrate in its position. However, doing so appreciably slows down the imaging process relative to the amount of time in which a parallel imaging system can image the sample.

### SUMMARY

Using an imaging system to quickly provide a user with sample monitoring information, such as sample positioning and (self-)stabilization, could appreciably reduce the amount of time required to produce high quality images of a sample. For example, instead of having to estimate an amount of time appropriate to allow a sample to (self-)stabilize, a sample could be monitored in real time using an imaging system enabling imaging immediately once sufficient (self-)stabilization has been achieved. Sufficiency could be determined automatically by the imaging system or by a user who subsequently provides an input to begin imaging. While certain methods could be used to provide test images, for example by scanning at a lower resolution or over a partial scan pattern to generate a partial image, test images may themselves (undesirably) require appreciable time to acquire. (Examples of methods for acquiring test scans are disclosed in U.S. patent application Ser. No. 17/174,919, filed on Feb. 12, 2021, the disclosure of which is hereby incorporated by reference herein in its entirety.) The present disclosure further improves on such “test image” methods by providing methods in which images are acquired at fast speeds without scanning any objective (e.g., micro optical element array) or sample. A fixed micro optical element array enables light from a sample (e.g., fluorescence) to be quickly collected and then received (e.g., at a detector) from a micro optical element array to form image(s) in real time. Such images may be relatively low resolution (compared to full resolution images made by scanning) but can still provide a user with valuable sample information. The information can be used to make a real time assessment of, for example, sample positioning, motion, and/or stabilization that can assist in subsequently producing higher quality full resolution images (e.g., by scanning a micro optical element array over a scan pattern) without undue delay, where the full resolution images are higher quality at least in part due to reduced or eliminated sample motion artifacts. The information can, alternatively or additionally, provide live feedback to a user to assist the user in (re-)positioning the sample to obtain one or more images of better quality, more quickly.

Generally, when imaging a surface of resected tissue samples as part of a clinical procedure (e.g., for intraoperative margin assessment), it is desirable to maximize the size of an imaged area of the sample, to minimize the risk of not imaging a region of high clinical interest (e.g., missing a positive margin). This can be achieved by imaging the different faces of a sample (e.g., sequentially), but also by ensuring that for a given image of a given sample face, a larger proportion of that sample face is in focus and thus imaged by the imaging system. It is also desirable to avoid presence of sample motion induced artifacts that may be disturbing for interpretation of the image (e.g., by a user or by an image processing or recognition algorithm) and therefore important to know whether a sample is undergoing sample motion or is unstable prior to imaging.

Systems and methods disclosed herein utilize rapid image generation and display by imaging a sample with a parallel imaging system (e.g., using a micro optical element array that collects and transmits sample light) without scanning (e.g., either the array or sample) to enable a fast initial assessment of the sample's current state to be made. The fast initial assessment may be used to achieve the aforementioned desires of maximizing area of the sample in focus and reducing sample motion artifacts in full images by avoiding initiating imaging before a sample has sufficiently stabilized. Imaging time can be reduced when a micro optical element array is fixed during imaging because time needed to separately collect light at multiple positions in a scan pattern is eliminated. Imaging without scanning may result in relatively low resolution images, for example where neighboring image pixels correspond to sample light received from micro optical elements in an array for different locations in the sample, the different locations being separated by a distance corresponding to a pitch of micro optical elements. That is, in some embodiments, images obtained without scanning may be obtained by a reconstruction process that assigns each image pixel a value (e.g., intensity value) corresponding to light collected by one micro optical element in an array. (Other embodiments may use other methods, for example direct imaging with a detector (which foregoes the need for a reconstruction process) or indirect imaging.) However, even at low resolution, such images provide useful information to a user or image processing or recognition algorithm. Being able to generate, and in some embodiments display, such images in real time enables a user or image processing or recognition algorithm to quickly determine, for example, when a sufficiently maximal area of a sample is in focus and/or when a sample has (self-)stabilized to a sufficient extent before launching acquisition of a high-resolution image, so as to produce an image free or substantially free of disturbing motion artifacts.

In some embodiments, methods of the present disclosure provide a live view mode to a user and/or an image processing or recognition algorithm. In some embodiments, without scanning (e.g., of a micro optical element array), successive image(s) are generated, and optionally displayed to a user, that comprise image pixels that represent sample light received from micro optical elements in an array for different, spatially distinct locations in a sample. Because a micro optical element array can be relatively large in one or more spatial dimensions and include a large number of micro optical elements, images can be of a useful size and resolution to obtain sample information indicative of a real time state of the sample. In this way, current sample information for samples can be obtained and monitored. A user may adjust a sample on a mounting surface (e.g., of a sample dish) based on a live view mode to alter its position or increase its area that is in focus. A user may also determine that a sample has sufficiently (self-)stabilized and initiate a full image acquisition by scanning a micro optical element array accordingly. In some embodiments, (self-)stabilization is determined by an image processing or recognition algorithm and imaging by scanning is then automatically initiated.

In some embodiments, methods of the present disclosure provide images including a stabilization index to a user and/or an image processing or recognition algorithm. A stabilization index that represents an empirically derived quantitative assessment of a degree of stabilization may be determined (e.g., calculated) for sample light received from one or more micro optical elements that are represented by one or more image pixels in an image (e.g., each image pixels or region of image pixels). A stabilization index of one or more image pixels may be reflective of how much intensity of sample light is changing for the one or more image pixels over some period of time. A higher stabilization index value may indicate more fluctuation and therefore imply more sample motion is occurring in real time. An image may include an indication of a stabilization index for each of a plurality of regions, each corresponding to a cluster of micro optical elements in an array. Decreasing stabilization index values over time may indicate that a sample is getting closer to being (self-)stabilized. While a live view mode may be helpful, it may be difficult for a user to tell how much a sample is actively stabilizing (e.g., relaxing or otherwise moving) based purely on representations of intensity of sample light, even in real time. A live view mode may be presented with a stabilization index overlay to provide additional information, e.g., to a user, that assists in more quickly and easily understanding whether a sample is or is not (self-)stabilized.

In some embodiments, a method is directed to providing live sample monitoring information to a user. The method may include generating (e.g., and displaying), by a processor of a computing device, in real time, one or more images (e.g., frames of a video) of a sample based, at least in part, on sample light (e.g., fluorescence) received from micro optical elements (e.g., refractive lenses, Fresnel zone plates, reflective objectives, and gradient-index (GRIN) lenses) in a micro optical element array without scanning the array or the sample. In some embodiments, an imaging system comprises the micro optical element array and no part of the imaging system is moved (e.g., scanned) while generating (e.g., and displaying) the one or more images.

In some embodiments, for each of the one or more images, neighboring pixels in the image represent portions of the sample light (e.g., fluorescence) received from ones of the micro optical elements for different locations in the sample, the different locations separated by a characteristic distance for the array (e.g., corresponding to a pitch of the micro element array) (e.g., a separation in spot size centers for adjacent ones the micro optical elements). In some embodiments, image pixels of each of the one or more images correspond to sample light (e.g., fluorescence) received from micro optical elements in the array.

In some embodiments, the array remains in a fixed position during the generating (e.g., and the displaying). In some embodiments, the sample is unperturbed (e.g., not manipulated) during the generating.

In some embodiments, the image pixels individually correspond to sample light (e.g., fluorescence) received from respective micro optical elements in the array. In some embodiments, each of the image pixels corresponds to sample light received from one of the micro optical elements in the array (e.g., and wherein each of the micro optical elements in the array corresponds to only one of the image pixels) (e.g., wherein each of the image pixels corresponds to sample light received from a respective one of the micro optical elements in the array).

In some embodiments, the method comprises determining (e.g., automatically by the processor) whether a bubble is represented in one or more of the one or more images. In some embodiments, determining whether a bubble is represented comprises automatically determining, by the processor, whether an area of image pixels having zero pixel value that is larger than a threshold area (e.g., corresponding to a size of a cluster of no more than 50, no more than 25, no more than 10, or no more than 5 micro optical elements in the array) is present in the one or more of the one or more images (e.g., for a period of time, e.g., of at least 1 s, at least 2 s, or at least 5 s). In some embodiments, determining whether a bubble is represented comprises automatically determining, by the processor, whether a perimeter of an area of image pixels having zero pixel value defined by image pixels having non-zero pixel values is present in the one or more of the one or more images (e.g., for a period of time, e.g., of at least 1 s, at least 2 s, or at least 5 s). In some embodiments, the method comprises adjusting the sample (e.g., by weighting and/or repositioning the sample) in response to determining that no bubble is represented in the one or more of the one or more images.

In some embodiments, the method comprises determining (e.g., automatically by the processor) whether the sample has sufficiently large area that is in focus in one or more of the one or more images. In some embodiments, determining whether the sample has the sufficiently large area that is in focus comprises automatically determining, by the processor, whether an area of image pixels with non-zero pixel values is above a pre-determined threshold (e.g., set by the user, e.g., based on the sample size). In some embodiments, determining whether the sample has the sufficiently large area that is in focus comprises automatically determining, by the processor, whether a convex hull of ones of the images pixels with non-zero pixel values changes by no more than 10% (e.g., no more than 5%, or no more than 1%) over a period of time (e.g., of at least 1 s, at least 2 s, or at least 5 s). In some embodiments, the method comprises adjusting the sample (e.g., by weighting and/or repositioning the sample) in response determining whether the sample has the sufficiently large area that is in focus in the one or more of the one or more images.

In some embodiments, the method comprises adjusting the sample during the generating (e.g., and the displaying) in response to the one or more images.

In some embodiments, the sample is accessible to a user during the generating (e.g., and the displaying) [e.g., is disposed on a sample dish that allows (e.g., lateral) sample access during imaging].

In some embodiments, the method comprises initiating imaging of the sample based on the one or more images [e.g., based on determining one or more of the one or more images are sufficient to indicate the sample has stabilized (e.g., self-stabilized)], wherein imaging the sample comprises scanning the micro optical element array. In some embodiments, the method comprises initiating the imaging automatically by the processor in response to determining one or more of the one or more images are sufficient to indicate the sample has stabilized (e.g., self-stabilized). In some embodiments, determining the one or more of the one or more images are sufficient to indicate the sample has stabilized occurs automatically by the processor. In some embodiments, determining the one or more of the one or more images are sufficient to indicate the sample has stabilized comprises determining, by the processor, that no bubble is represented in the one or more of the one or more images. In some embodiments, determining the one or more of the one or more images are sufficient to indicate the sample has stabilized comprises determining, by the processor, that the sample has sufficiently large area that is in focus in the one or more of the one or more images.

In some embodiments, the one or more images are greyscale image(s). In some embodiments, the one or more images are false color image(s) (e.g., wherein pixels in the image(s) are displayed on a purple/pink color scale, e.g., mimicking a hematoxylin and eosin stained optical microscopy image). In some embodiments, hue, saturation, brightness, or a combination thereof (e.g., grey value) of the image pixels corresponds to relative intensity of the sample light received.

In some embodiments, the method comprises determining, by the processor, a stabilization index for the sample light for each of at least a portion of (e.g., all of) the micro optical elements in the array based on comparing the sample light received from the micro optical element over an observation period, wherein the one or more images comprise a graphical indication (e.g., icon, shading, graphic, or color) of the stabilization index. In some embodiments, the stabilization index is dynamic over the observation period. In some embodiments, the stabilization index changes over the observation period of time based on changes in the sample light received from the micro optical element.

In some embodiments, the method comprises determining, by the processor, the stabilization index by comparing changes in intensity of the sample light received from the micro optical element over a calculation period (e.g., that is a subset of the observation period). In some embodiments, comparing the changes in intensity of the sample light comprises determining, by the processor, a minimum intensity and a maximum intensity of the sample light received from each of the micro optical elements over the calculation period (e.g., a pre-determined number of detector frames, e.g., set by a user). In some embodiments, the minimum intensity and the maximum intensity are each determined from a weighted average (e.g., an exponential weighted average) (e.g., a weighted time-average) (e.g., wherein one or more weighting parameters are set by a user) (e.g., wherein the weighted average is calculated using intensity of sample light received from the micro optical elements over more than one sequential period) for the micro optical element over the calculation period. In some embodiments, the stabilization index is a difference between the maximum intensity and the minimum intensity.

In some embodiments, each of the one or more images comprises regions each comprising a graphical indication (e.g., icon, shading, graphic, or color) of the stabilization index for every micro optical element corresponding to that region. In some embodiments, the regions each correspond to a respective cluster of at least 9 micro optical elements (e.g., at least 16 micro optical elements, at least 25 micro optical elements, at least 49 micro optical elements, or at least 64 micro optical elements). In some embodiments, the method comprises: determining, by the processor, for each of the regions, an average of the stabilization index for the micro optical elements corresponding to the region; and generating, by the processor, the graphical indication for the region based on the average. In some embodiments, generating the graphical indication comprises determining, by the processor, whether the average exceeds one or more thresholds (e.g., a plurality of thresholds) (e.g., received, by the processor, as input from the user) such the graphical indication is indicative of whether the one or more thresholds are exceeded by the average (e.g., based on a transparency, a brightness, a saturation, a hue, or a combination thereof).

In some embodiments, one or more of the one or more images comprise image pixels based in part on first sample light (e.g., fluorescence) received from micro optical elements in the array during the observation period combined with the graphical indication of the stabilization index. In some embodiments, the graphical indication of the stabilization index in the one or more of the one or more images is based on the first sample light and second sample light received prior to the first sample light.

In some embodiments, at least a portion of each of the one or more images comprises regions each comprising a respective graphical indication (e.g., icon, shading, graphic, or color) of a stabilization index for that region. In some embodiments, the method comprises determining, by the processor, the stabilization index for one of the one or more images based on one or more of the one or more images prior to the one of the one or more images.

In some embodiments, at least a portion of each of the one or more images comprises regions each comprising a respective graphical indication of motion of the sample for that region.

In some embodiments, the graphical indication is a color within the region (e.g., green or yellow or red) (e.g., wherein the graphical indication is based on a transparency, a brightness, a saturation, a hue, or a combination thereof for the region).

In some embodiments, the graphical indication is overlaid over image pixels corresponding to sample light (e.g., fluorescence) received from micro optical elements in the array.

In some embodiments, the method comprises displaying, by the processor, the one or more images as the one or more images are generated. In some embodiments, the method comprises repeatedly collecting the sample light received from the micro optical elements over a period of time such that the one or more images are generated and displayed at a rate of at least 4 images per second (e.g., at least 10 images per second, at least 20 images per second).

In some embodiments, the generating (e.g., and the displaying) is performed in real time such that the generating (e.g., and the displaying) are only delayed by time required for processing (e.g., with no time offset).

In some embodiments, image pixels in each of the one or more images correspond to sample light received from the micro optical elements over a period of time of no more than 0.25 s (e.g., no more than 0.1 s, no more than 0.05 s, no more than 0.025 s, no more than 0.01 s, or no more than 0.005 s). In some embodiments, the period of time is no more than 0.005 s.

In some embodiments, the sample is a freshly resected tissue sample (e.g., that has been fluorescently tagged with a staining agent).

In some embodiments, the method comprises receiving the sample light at a detector, wherein generating (e.g., and the displaying) the one or more images comprises processing, by the processor, signals from the detector. In some embodiments, the one or more images are displayed on a display (e.g., via one or more graphical user interfaces). In some embodiments, the display, the processor, and the micro optical element array are comprised in an imaging system (e.g., a mobile imaging system) (e.g., located in a room of a hospital, e.g., an operating room).

In some embodiments, the micro optical elements of the array have a lateral optical resolution of no more than 10 μm (e.g., no more than 5 μm, no more than 2 μm, or no more than 1 μm).

In some embodiments, an imaging system comprises a (e.g., the) processor and one or more non-transitory computer readable media (e.g., and a display and/or the micro optical element array), the one or more media having instructions stored thereon that, when executed by the processor, cause the processor to perform a method as disclosed herein.

In some embodiments, a method is directed to providing live sample monitoring information to a user. The method may include generating (e.g., and displaying), in real time, one or more images (e.g., frames of a video) of a sample based, at least in part, on sample light (e.g., fluorescence) received from micro optical elements (e.g., refractive lenses, Fresnel zone plates, reflective objectives, and gradient-index (GRIN) lenses) in a micro optical element array. In some embodiments, for each of the one or more images, neighboring pixels of in the image represent portions of the sample light (e.g., fluorescence) received from ones of the micro optical elements for different locations in the sample, the different locations separated by a characteristic distance for the array (e.g., corresponding to a pitch of the micro optical element array) (e.g., a separation in spot size centers for adjacent ones the micro optical elements). In some embodiments, none of (i) the array and (ii) the sample are scanned during the generating (e.g., and the displaying).

Any two or more of the features described in this specification, including in this summary section, may be combined to form implementations not specifically explicitly described in this specification.

At least part of the methods, systems, and techniques described in this specification may be controlled by executing, on one or more processing devices, instructions that are stored on one or more non-transitory machine-readable storage media. Examples of non-transitory machine-readable storage media include read-only memory, an optical disk drive, memory disk drive, and random access memory. At least part of the methods, systems, and techniques described in this specification may be controlled using a computing system comprised of one or more processing devices and memory storing instructions that are executable by the one or more processing devices to perform various control operations.

### Definitions

In order for the present disclosure to be more readily understood, certain terms used herein are defined below. Additional definitions for the following terms and other terms may be set forth throughout the specification.

In this application, unless otherwise clear from context or otherwise explicitly stated, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; (iv) the terms “about” and “approximately” may be understood to permit standard variation as would be understood by those of ordinary skill in the relevant art; and (v) where ranges are provided, endpoints are included. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Image: As used herein, the term “image”, for example, as in a two- or three-dimensional image of resected tissue (or other sample), includes any visual representation, such as a photo, a video frame, streaming video, as well as any electronic, digital, or mathematical analogue of a photo, video frame, or streaming video. In some embodiments, one or more images generated and/or displayed by a method disclosed herein may be displayed sequentially, like a video, having a certain frame rate, even if the frame rate is lower than that of standard video formats (e.g., 30 or 60 Hz). Any system or apparatus described herein, in certain embodiments, includes a display for displaying an image or any other result produced by a processor. Any method described herein, in certain embodiments, includes a step of displaying an image or any other result produced by the method. Any system or apparatus described herein, in certain embodiments, outputs an image to a remote receiving device [e.g., a cloud server, a remote monitor, or a hospital information system (e.g., a picture archiving and communication system (PACS))] or to an external storage device that can be connected to the system or to the apparatus. In some embodiments, an image is produced using a fluorescence imaging system, a luminescence imaging system, and/or a reflectance imaging system. In some embodiments, an image is a two-dimensional (2D) image. In some embodiments, an image is a three-dimensional (3D) image. In some embodiments, an image is a reconstructed image. In some embodiments, an image is a confocal image. An image (e.g., a 3D image) may be a single image or a set of images. In some embodiments, whether sample motion has occurred is reflected by the presence of one or more sample motion artifacts in an image (e.g., a full image or a test image). The one or more sample motion artifacts may be detectable by image processing performed by an imaging system. In some embodiments, determining whether one or more sample motion artifacts are present determines (e.g., is determinative of) whether sample motion has occurred.

User: As used herein, a user is any person who uses an imaging system disclosed herein. A user may be, for example, but not limited to, a surgeon, a surgical staff (e.g., a nurse or medical practitioner in an operating room), a lab technician, a scientist, or a pathologist. It is understood that when an action is described as being performed by a surgeon, in some embodiments, a user who is not a surgeon performs an equivalent function.

Real time: As used herein, images may be generated and/or displayed in “real time.” Generally, action occurring in real time occurs without intentional delay. There may be some amount of time required to process signal (e.g., from a detector that) and/or collect light (e.g., illuminate a sample and receive back-emitted sample light from). For example, in some embodiments image generation comprises providing illumination light through an optical module including a micro optical element array, collecting back-emitted sample light from a sample through the optical module, receiving the sample light at a detector, and processing signal from the detector to determine pixel values (e.g., greyscale values) for each image pixel in an image that is generated based on intensity of the sample light for each of the micro optical elements in the array. Thus, a “frame rate” at which images can be generated and displayed may be limited by such processing and/or collection time. For example, an effective frame rate may be at least 4 frames (images) per second (e.g., at least 10 frames per second, at least 15 frames per second, at least 20 frames per second, or at least 30 frames per second).

Sample: As used herein, a “sample” can be any material desired to be characterized. In some embodiments, a sample is a biological sample. In some embodiments, a sample is tissue, such as human tissue. In some embodiments, tissue is fresh (e.g., not fixed). In some embodiments, tissue is freshly resected. For example, a tissue sample may be resected during a surgical procedure and, optionally, imaged using a method disclosed herein intraoperatively. Similarly, “sample light” is light from a sample. Sample light may be, for example, reflected light, refracted light, diffracted light, or back-emitted light. In some embodiments, sample light is fluorescence. Sample light that is fluorescence may be back-emitted light from a sample that is emitted from one or more fluorescent tags applied to the sample by a stain (e.g., that selectively stain feature(s) of interest within a sample).

Stabilization: As used herein, “stabilization” refers to a reduction (e.g., elimination) in sample movement (e.g., over a period of time). Stabilization may be self-stabilization, for example resulting from sample relaxation. Unless otherwise clear from context, references to “stabilization” that are not preceded by “self-” or “(self-)” should be understood to indicate that embodiments where the stabilization being discussed is self-stabilization are contemplated. Stabilization may also be achieved using tools manipulated by a user, such as forceps or a sample weighting tool. Stabilization may have occurred once any remaining sample motion is below a detectable threshold (e.g., wherein sample motion occurs only a time scale much longer than a sampling period over which sample light is received from a micro optical element array). A stabilization index may therefore represent an empirically derived quantitative assessment of a degree of stabilization present at a certain time or over a certain period of time, for example determined by changes in intensity of sample light received from micro optical elements in an array. Thus, a higher stabilization index value can indicate relatively more sample motion as inferred from larger changes in intensity of sample light received.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Drawings are presented herein for illustration purposes, not for limitation. The foregoing and other objects, aspects, features, and advantages of the disclosure will become more apparent and may be better understood by referring to the following description taken in conjunction with the accompanying drawings, in which:

FIGS. 1A and 1B are plan views representing an illustrative rectangular optical chip comprising an array of micro lenses disposed in a square lattice, according to illustrative embodiments of the present disclosure;

FIG. 1C is a cross section of a portion of the optical chip illustrated in FIGS. 1A and 1B, according to illustrative embodiments of the present disclosure;

FIG. 2A is a schematic of an illustrative imaging system showing illumination of a tissue sample, according to illustrative embodiments of the present disclosure;

FIG. 2B is a schematic of the illustrative imaging system according to FIG. 2A showing detection of back-emitted light from a sample by a detector, according to illustrative embodiments of the present disclosure;

FIGS. 3A-3C are process diagrams of methods for determining whether a sample has moved using a stationary micro optical element array, according to illustrative embodiments of the present disclosure;

FIGS. 4A-4D are process diagrams of methods for generating, and optionally displaying, images in real time without scanning, according to illustrative embodiments of the present disclosure;

FIG. 4E is an illustration of methods for calculating stabilization indices, according to illustrative embodiments of the present disclosure;

FIGS. 5A-5D are images illustrating using a live view mode to monitor sample area that is in focus over time, which grows due to repositioning by a user, according to illustrative embodiments of the present disclosure;

FIGS. 6A-6E are images illustrating using a live view mode to monitor for presence of bubbles with a sample, which shrink due to repositioning by a user, according to illustrative embodiments of the present disclosure;

FIGS. 7A-7D are images illustrating using a live view mode with a semi-transparent stabilization index view overlay to monitor sample motion and stabilization over time, which becomes less over time due to sample relaxation, according to illustrative embodiments of the present disclosure;

FIG. 7E shows a live view mode of the sample without a stabilization index mode overlay, according to illustrative embodiments of the present disclosure;

FIG. 8A is an example screen capture of a graphic user interface showing a live view mode image with stabilization index overlay and summary statistics, according to illustrative embodiments of the present disclosure;

FIG. 8B is an example screen capture of a graphic user interface showing a live view mode image with stabilization index overlay and time-resolved summary statistics, according to illustrative embodiments of the present disclosure;

FIG. 8C is an example screen capture of a graphic user interface showing a greyscale live view mode image with stabilization index overlay and user-selectable stabilization index weighting parameters and thresholding, according to illustrative embodiments of the present disclosure;

FIG. 8D is an example screen capture of a graphic user interface showing a false color (histological stain mimicking) live view mode image with stabilization index overlay and user-selectable stabilization index weighting parameters and thresholding, according to illustrative embodiments of the present disclosure;

FIG. 9 is a block diagram of an example network environment for use in the methods and systems described herein, according to illustrative embodiments of the present disclosure; and

FIG. 10 is a block diagram of an example computing device and an example mobile computing device, for use in illustrative embodiments of the present disclosure.

### DETAILED DESCRIPTION OF CERTAIN EMBODIMENTS

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps.

It should be understood that the order of steps or order for performing certain action is immaterial so long as operability is not lost. Moreover, two or more steps or actions may be conducted simultaneously.

Headers are provided for the convenience of the reader and are not intended to be limiting with respect to the claimed subject matter.

### Examples of Arrays of Micro Optical Elements and Imaging Systems

In some embodiments, an imaging system used to image, with or without scanning (e.g., depending on image type being acquired), includes an array of micro optical elements that may include one or more of refractive lenses, Fresnel zone plates, reflective objectives, and gradient-index (GRIN) lenses. An array of micro optical elements may be scanned over a scan pattern during imaging, for example by a scanning stage that includes an actuator. A scan pattern may have a size that corresponds to a size of a unit cell for a micro optical element in an array of micro optical elements (e.g., be squares of approximately equivalent size). In such a way, each micro optical element in an array of micro optical elements may scan an area corresponding to its unit cell in order to produce an image corresponding in size (e.g., having a size of the same order of magnitude) as the array of micro optical elements. A scan pattern may include a series of sequential positions (e.g., disposed in an array, such as a regular array) that are moved to sequentially during imaging. An array of sequential positions defining a scan pattern may generally be an M×N array where M=N or M≠N. Illumination light may be provided to a sample through an array of micro optical elements at a subset (e.g., all) of the sequential positions in a series (e.g., array). Back-emitted light may be collected from a sample with an array of micro optical elements at a subset (e.g., all) of the sequential positions in a series (e.g., array), for example when an imaging system is a fluorescence microscope, such as a confocal microscope.

In some embodiments, an imaging system is disposed in an operating room and used during surgical procedures (e.g., diagnostic procedures or treatment of a diagnosed illness). In some embodiments, systems are used and/or methods are performed intraoperatively.

An array of micro optical elements may be disposed on a surface of an optical chip. For example, the micro optical elements may be disposed on a surface of a substrate of an optical chip. In some embodiments, an optical chip includes an array of micro optical elements attached to a holder around the periphery of the array (e.g., is not disposed on a substrate). Generally, the outer perimeter of an optical chip can have any shape. In some embodiments, an optical chip is a rectangle (e.g., a square or a non-square). For example, in some embodiments, an array of micro optical elements is integral with a substrate of an optical chip. An array of micro optical elements can be non-integral, but attached to a substrate of an optical chip. An array of micro optical elements may include at least 25,000 micro lenses (e.g., with a radius of curvature (ROC) of between 200 μm and 300 μm. An absorptive and/or reflective layer may be provided on an optical chip between micro optical elements in an array (e.g., to act as an aperture). An optical chip may be made of fused silica. Micro optical elements may be arranged in a regular array on an optical chip (e.g., a square lattice). In some embodiments, an array of micro optical elements has a pitch of from 100 μm to 500 μm (e.g., from 200 μm to 300 μm). In some embodiments, an optical chip has a non-regular array of micro optical elements, for example, having a different pitch in an x-direction and a y-direction. In some embodiments, an optical chip has a high numerical aperture for high resolution imaging and more efficient background rejection.

In some embodiments, an array of micro optical elements is not part of an optical chip. For example, in some embodiments, an array of micro optical elements is an array of discrete objectives, for example that are mounted (e.g., to each other or to a physical support) in a fixed relative position.

In some embodiments, an array of micro optical elements is a regular array and a pitch of micro optical elements in the array in a first direction equals a pitch of micro optical elements in the array in a second direction that is perpendicular to the first direction. For example, micro optical elements may be arranged in a square lattice. In some embodiments, each micro optical element of an array of micro optical elements has at least one convex surface. For example, each micro optical element may be a planoconvex lens or a biconvex lens. A convex surface of each micro optical element may have a shape obtained by the revolution of a conic section (e.g., with a radius of curvature of between 200 μm and 300 μm). In some embodiments, each micro optical element in an array of micro optical elements focuses light onto an area (spot) smaller than a pitch (e.g., the pitch) of the array. In some embodiments, micro optical elements in an array of micro optical elements collectively focus onto a common focal plane. For example, each element of an micro optical element array may focus onto a single point on the common focal plane.

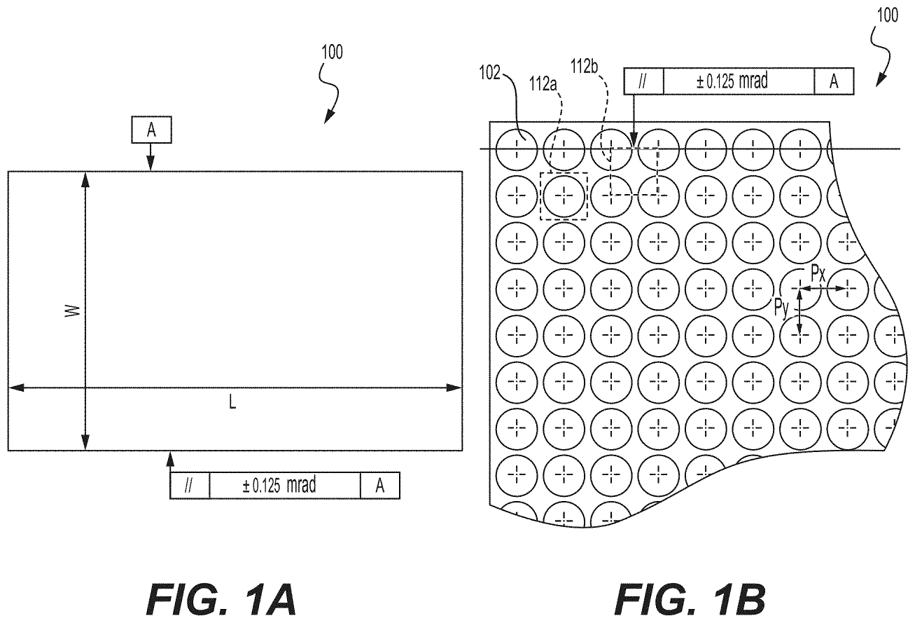

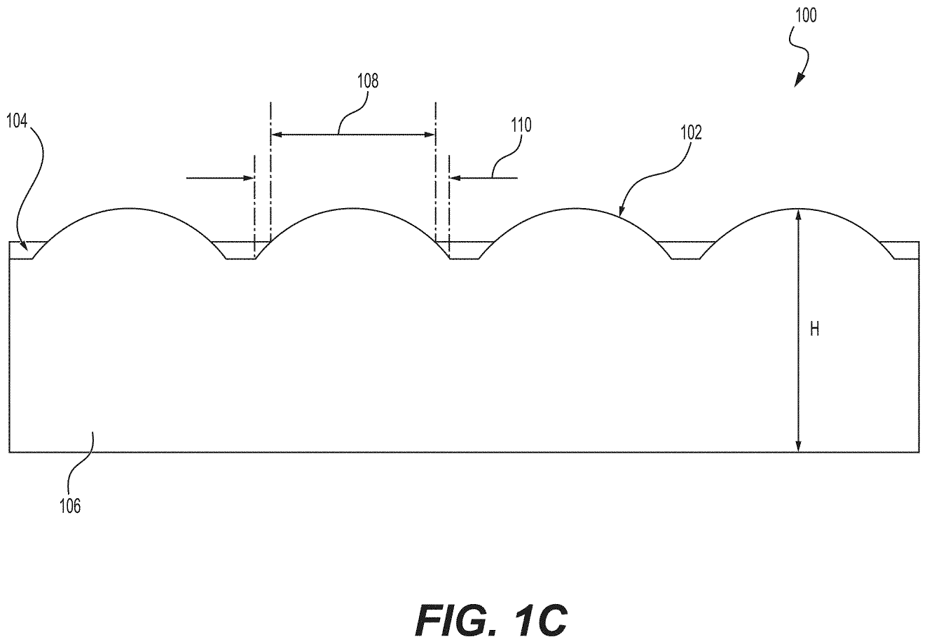

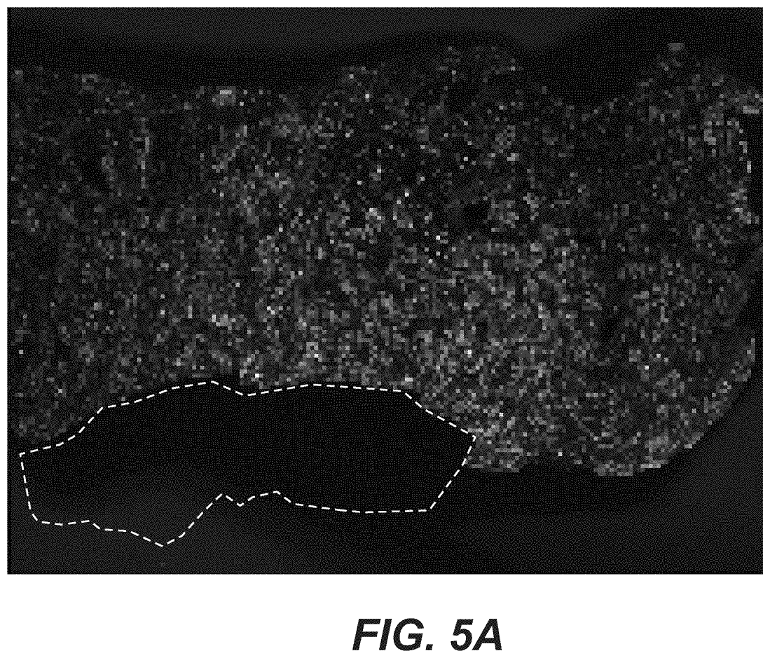

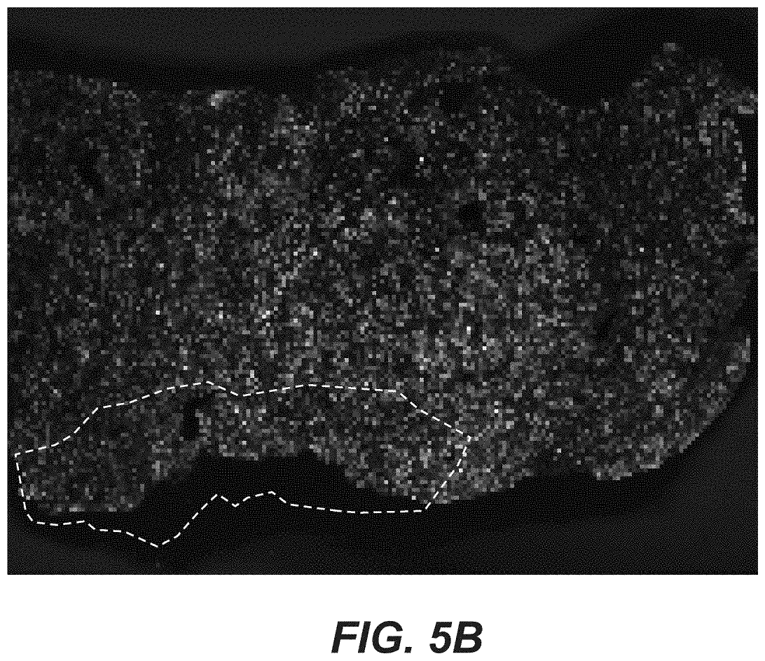

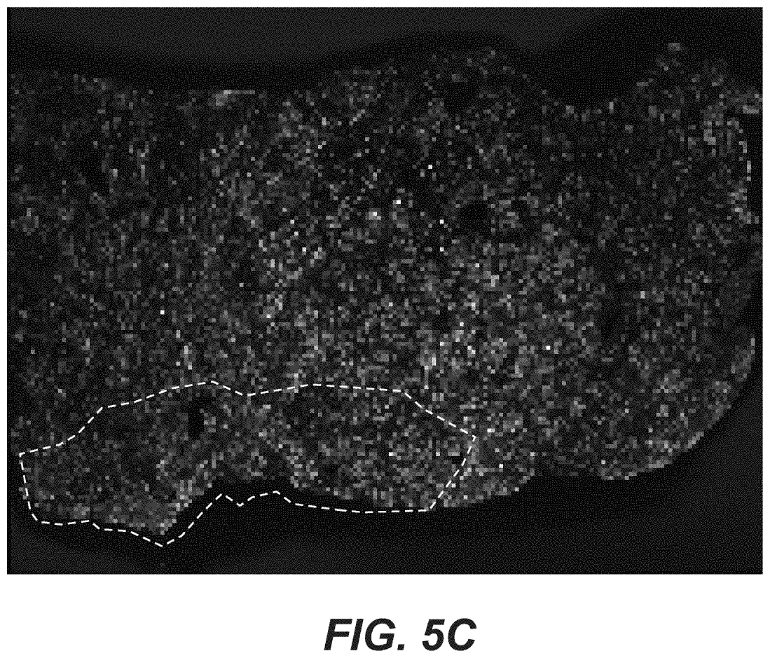

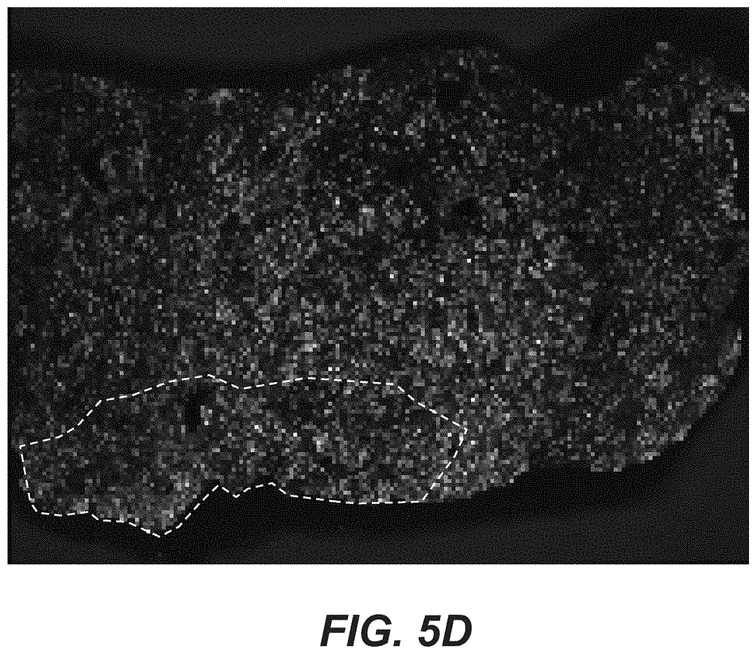

FIG. 1A and FIG. 1B schematically illustrate two views of illustrative optical chip 100 that includes an array of micro optical elements 102, which may be used in systems disclosed herein and/or to perform methods disclosed herein. FIG. 1A shows a plan view of the entirety of optical chip 100 (individual micro optical elements and optional reflective/absorptive layer are not shown in FIG. 1A). Optical chip 100 has a rectangular cross section having dimensions W and L (i.e., with W≠L). In some embodiments, W=L. Optical chip 100 has high parallelism with edges of optical chip 100 having a parallelism of better than about ±0.250 mrad (e.g., no more than or about ±0.125 mrad). FIG. 5B shows a portion of optical chip 100 including a portion of array of micro optical elements 102. An array of micro optical elements disposed on a surface of optical chip 100 may include at least 1,000 micro optical elements, at least 5,000 micro optical elements, at least 10,000 micro optical elements, at least 20,000 micro optical elements, at least 30,000 micro optical elements, at least 50,000 micro optical elements, at least 60,000 micro optical elements, or at least 100,000 micro optical elements. Array of micro optical elements 102 is highly parallel relative to edges of optical chip 100. Array 102 has a parallelism relative to edges of an optical chip of better than about ±0.250 mrad (e.g., no more than or about ±0.125 mrad). Array 102 is a regular array. In some embodiments, an array of micro optical elements is non-regular. Dashed box 112a shows an example of a unit cell of a micro optical element in array 102. Dashed box 112b shows an example of a unit cell of a micro optical element in array 102 drawn with a different origin than for dashed box 112a. In general, the selection of origin is arbitrary. Crosshairs in each micro optical element of array 102 indicate the respective centers of the micro optical elements.

FIG. 1C shows a diagram of a cross section of a portion of an illustrative optical chip 100. Optical chip 100 includes a substrate 106 and an array of micro optical elements. Each micro optical element 102 is a convex microlens. The convex microlenses 102 are integral with the substrate 106 such that the substrate 106 and microlenses 102 are together one continuous material. For example, they may be formed simultaneously during fabrication. The thickness (H) of optical chip 100 can be taken as the distance between the top of the micro optical elements and the opposite surface of the substrate, as shown. Thickness of an optical chip may be less than 2.0 mm (e.g., less than 1.5 mm or about 1.5 mm). An optical chip may have a total thickness variation and/or total flatness deviation of less than 20 μm (e.g., less than 15 μm, less than 10 μm, or less than 5 μm). Optical chip 100 is coated with a reflective layer 104 of chromium. Reflective layer 104 is disposed in inter-lens area between micro optical elements 102. It is understood that a reflective layer disposed in an inter-lens area may extend partially onto one or more lenses near the periphery of the lens(es) as shown in FIG. 1A and FIG. 1B. If a reflective layer 104 extends partially over micro optical elements near peripheries of the micro optical elements, a micro optical element diameter 110 is larger than a reflective layer aperture 108 formed by reflective layer 104.

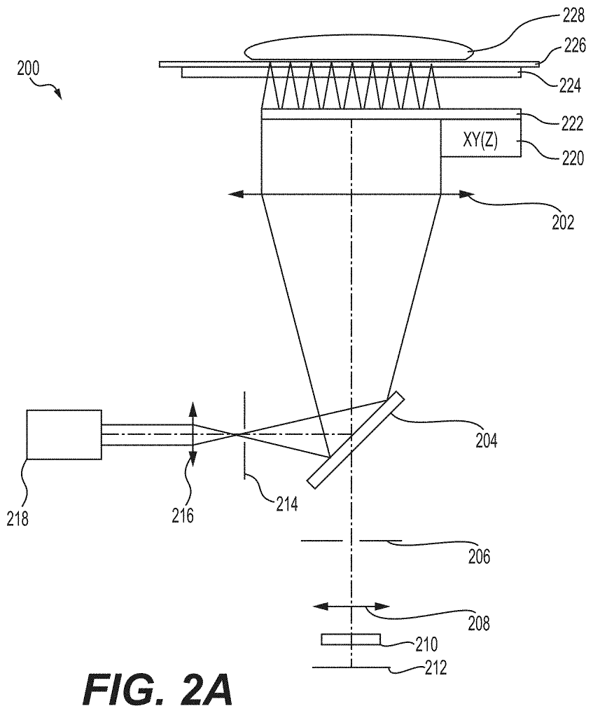

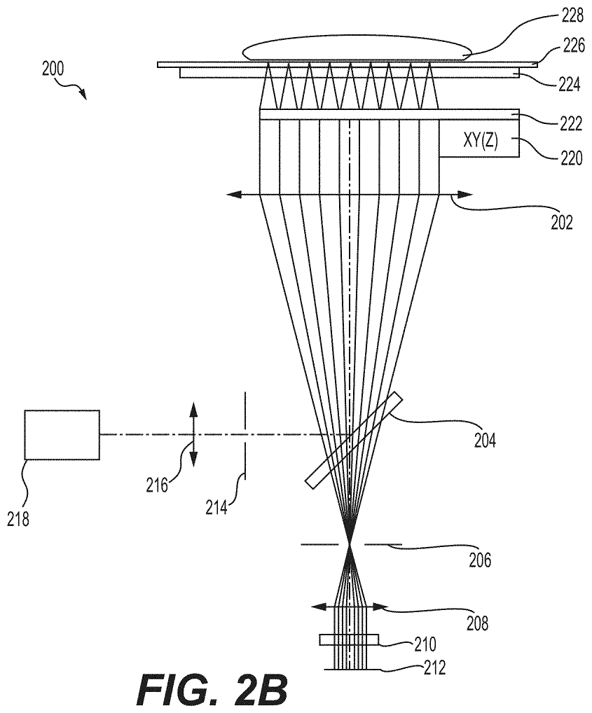

FIG. 2A is a schematic of illustrative imaging system 200 showing behavior of optics of the illustrative system during illumination of a tissue sample. Imaging system 200 may include features set forth herein and/or may be used to perform methods disclosed herein. FIG. 2B is a schematic illustrative imaging system 200 showing detection of back-emitted light from a sample by a detector. Referring now to FIG. 2A, a laser 218 that provides light with a wavelength that is between 450 nm and 490 nm provides an illumination beam to a focusing lens 216. The illumination beam passes through the focusing lens 216 and a first aperture 214 before being directed by a dichroic mirror 214. The dichroic mirror reflects the illumination beam onto a collimating lens 202. The illumination beam is collimated by collimating lens 202 and the collimated illumination beam propagates to an optical chip 222. The optical chip includes an array of micro optical elements. Micro optical elements in an array of micro optical elements may be refractive lenses, Fresnel zone plates, reflective objectives, GRIN lenses, or micro lenses. In certain embodiments, an optical chip includes an array of refractive micro lenses. The micro optical elements focus light from the collimated illumination beam onto a sample through an imaging window. In this case, a sample 228 is disposed on a disposable sample holder 226 that is mounted directly onto an imaging window 224. In some embodiments, a sample is disposed over an imaging window (e.g., on a sample dish) (e.g., without contacting the imaging window) during imaging. In some embodiments, sample holder 226 is not present and a sample is mounted directly on a transparent imaging window during imaging. Use of a sample dish may reduce or eliminate the need to clean (e.g., sterilize) a transparent imaging window when changing samples. FIG. 25 shows a sample dish 2504 mounted on a transparent imaging window 2502 with sample 2520 disposed therein, as an example of an imaging system 2500 that can be and/or is used with a sample dish 2502. Imaging system 200 may be similarly modified or designed.

Referring again to FIG. 2A, optical chip 222 is connected to a support of a scanning stage 220. Scanning stage 220 moves optical chip 222 along a scan pattern during imaging using a controller and an actuator connected to the support. Each micro optical element of optical chip 222 produces a tight focus (e.g., a small spot, e.g., unique point) of light from the collimated illumination beam on or in a sample during imaging on a common focal (imaging) plane that is on or in the sample. A scan pattern over which optical chip 222 is moved may be one dimensional or two dimensional.

FIG. 2B is a schematic of illustrative imaging system 200 showing behavior of the optics shown in FIG. 2A during detection. Light from the collimated illumination beam focused onto the sample 228 by the array of micro optical elements in the optical chip 222 produces light (e.g., fluorescence or luminescence) in the sample 228 that is back-emitted through imaging window 224 towards optical chip 222. Back-emitted light is then collected by the micro optical elements in the array in optical chip 222 and directed towards a detector 212. Back-emitted light passes through dichroic mirror 204 as it is within the transmission band of the mirror. Back-emitted light then passes through a second aperture 206 and is collimated by an imaging lens 208. The collimated back-emitted light passes through an emission filter 210 and then onto a detector 212. Detector 212 is a CMOS camera that includes an array of detector elements (e.g., pixels in the camera) that each receive back-emitted light from a micro optical in the array of optical elements in optical chip 222. An opaque enclosure may be disposed about an optical path of the back-emitted light that passes through filter 210 in order to block ambient (e.g., stray) light from being incident on detector 212.

In some embodiments, an image of a micro optical element array is captured by a detector (e.g., a detector element array such as a CMOS or a CCD camera). A frame of the detector may be processed to generate an image of the sample in which each image pixel represents the signal from a unique and different micro optical element in the array. In these images, two neighboring pixels represent the intensity collected from two points in the sample, separated by a distance corresponding to the pitch of the micro element array.

In some embodiments, an imaging system may be designed and calibrated such that one micro optical element is imaged on exactly one detector element. In some such embodiments, detector frames without further processing already constitute images of a sample in which one pixel represents signal from a unique and different micro optical element in the array.

In some embodiments, one micro optical element is imaged over many detector elements (e.g., on >4, >9, >16, >25, >100 detector elements). In some such embodiments, the intensity collected by a unique micro optical element may be calculated from the values of the many detector elements over which this micro optical element is imaged (e.g. by summing or interpolating the detector element values), so as to reconstitute an image in which each image pixel represents the signal from a unique and different micro optical element in the array.

An imaging system may be used for in-operating-theatre imaging of fresh tissue resected during surgery (e.g., cancer surgery). In some embodiments, an imaging system is operable to image a portion of a sample in less than 10 minutes (e.g., less than 5 minutes, less than 3 minutes or less than 2 minutes). In some embodiments, a system is operable to image a portion of the sample in less than 2 minutes (e.g., less than 90 seconds or less than 1 minute). In some embodiments, the portion of the sample has an area of at least 10 cm² (e.g., at least 12 cm², at least 15 cm², or at least 17 cm²). In some embodiments, a sample has a volume of no more than 10 cm×10 cm×10 cm and the system is configured to image a full outer surface of the sample in an imaging time of no more than 45 minutes (e.g., no more than 30 minutes).

Imaging systems usable to perform methods disclosed herein are generally point-scanning imaging systems. That is, in some embodiments, each micro optical element in a micro optical element array images a unique point (e.g., as opposed to a small field). In some embodiments, an imaging system is a confocal imaging system (e.g., a confocal microscope). Confocal imaging systems, as an example, enable high-resolution imaging of a sample by scanning a micro optical element array (e.g., comprised in an optical chip) over a scan pattern. A live view mode and/or stabilization index mode may be used prior to scanning to determine sample information, such as a qualitative assessment of sample self-stabilization, in order to further improve image quality during scanning (e.g., due to reduced sample motion artifacts that are more likely to occur and/or occur at greater magnitude prior to self-stabilization), as discussed further below.

In general, an imaging system can use any suitable method to generate images from light (e.g., back-emitted sample light) collected by a micro optical element array, with or without scanning. In some embodiments, an imaging system generates images to characterize a sample by scanning a micro optical element array in a lateral scan pattern (e.g., 2D scan pattern), for example as described for embodiments disclosed in U.S. Pat. No. 10,094,784. A detector and the sample may remain in a fixed relative position during imaging while the sample and the micro optical element array are in relative motion. A reconstruction process may be used to reconstruct an image using information derived from the light collected at each position in the lateral scan pattern and known position information for the micro optical element array. A similar reconstruction process may be used when performing sample monitoring to determine whether sample motion is occurring, even when the micro optical element array is not scanned (remains stationary). That is, an imaging system may be constructed to apply a similar reconstruction process during sample motion monitoring as a reconstruction process used during subsequent imaging. In some embodiments, a reconstruction process assigns to one image pixel a value (e.g., intensity value) corresponding to light collected by one micro optical element in an array. However, such a reconstruction process is not necessary to practice embodiments disclosed herein, independent of whether such a reconstruction process is used for subsequent imaging. For example, in some embodiments, sample motion monitoring is carried out using direct imaging from a detector. Other indirect imaging methods may also be used.

Imaging systems (e.g., confocal microscopes) that can be used in accordance with (e.g., to perform) certain embodiments of the present disclosure are discussed in U.S. Pat. Nos. 10,094,784 and 10,539,776, each of which is hereby incorporated herein in its entirety. Sample dishes that can be used in certain embodiments of the present disclosure are discussed in U.S. Pat. No. 10,928,621, the disclosure of which is hereby incorporated by reference herein in its entirety. Samples may be stained prior to imaging. For example, samples may be stained using a staining agent solution disclosed in U.S. patent application Ser. No. 16/806,555, filed on Mar. 2, 2020, the disclosure of which is hereby incorporated by reference herein in its entirety.

Sample Monitoring with Fixed Micro Optical Element Arrays

For a parallel imaging system, for example including an array of micro optical elements, imaging of a large sample area can be accomplished without motion of the optical elements (nor the sample). Intensity of sample light received from micro optical elements in the array can be detected to generate images comprising image pixels that individually correspond to the micro optical elements. Each image pixel may represent signal from multiple detector elements depending on the ratio of detector elements to micro optical elements in an imaging system. Intensity fluctuations in time would be larger for a sample that is moving significantly (e.g., compared to image resolution and/or imaging rate) than for a sample that is not moving significantly (e.g., compared to image resolution and/or imaging rate). A threshold amount may be set based on, for example, typical intensity variation between neighboring pixels in an image (e.g., for a given sample type), below which intensity fluctuations of the image pixel(s) would indicate sample motion is not occurring (e.g., compared to image resolution and/or imaging rate). Typical intensity variation may be known and/or determined based on image parameters (e.g., resolution) and/or sample characteristic(s). The threshold amount may be predetermined or determined during monitoring, for example as a percentage of intensity fluctuation over an initial period.

Such variations may also be used to determine (e.g., set) an intensity of sample light at or below which pixel values (e.g., grey values in a greyscale image) for corresponding image pixels in an image will be set to zero. That is, where only minimal intensity of sample light is received for certain micro optical elements, the intensity may not be sufficient to distinguish from background such that a pixel value of zero is assigned. Intensity of sample light may similarly be thresholded to bin small ranges of intensity to distinct hue, brightness, saturation, or combination thereof (e.g., distinct grey values in a grey scale) for image pixels. For example, detector signals may be normalized or baselined against a determined average intensity variation. In some embodiments, such as implementations of confocal imaging systems, optics in the imaging system eliminate out of focus background intensity with one or more apertures.

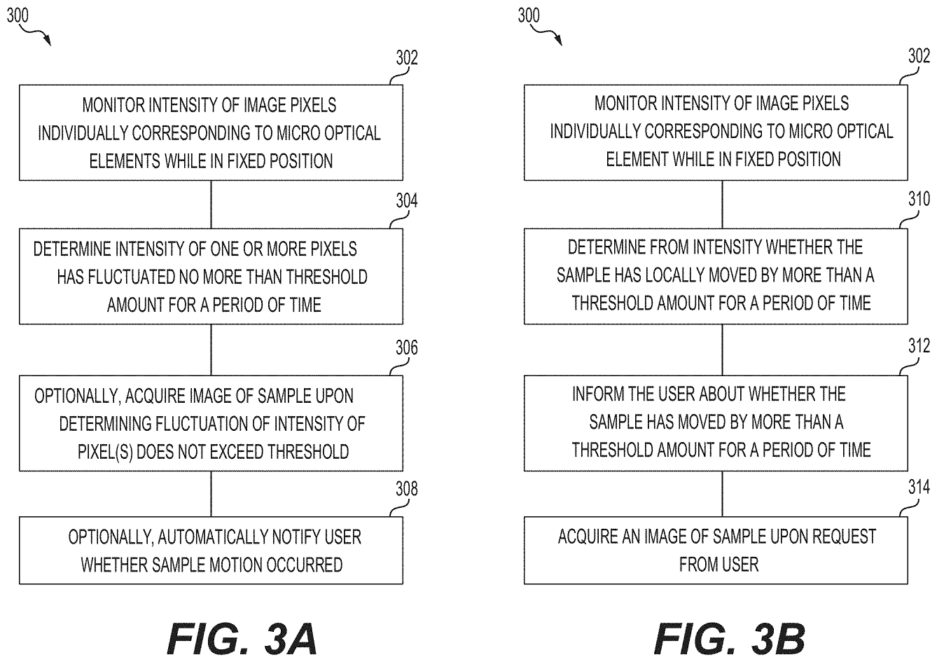

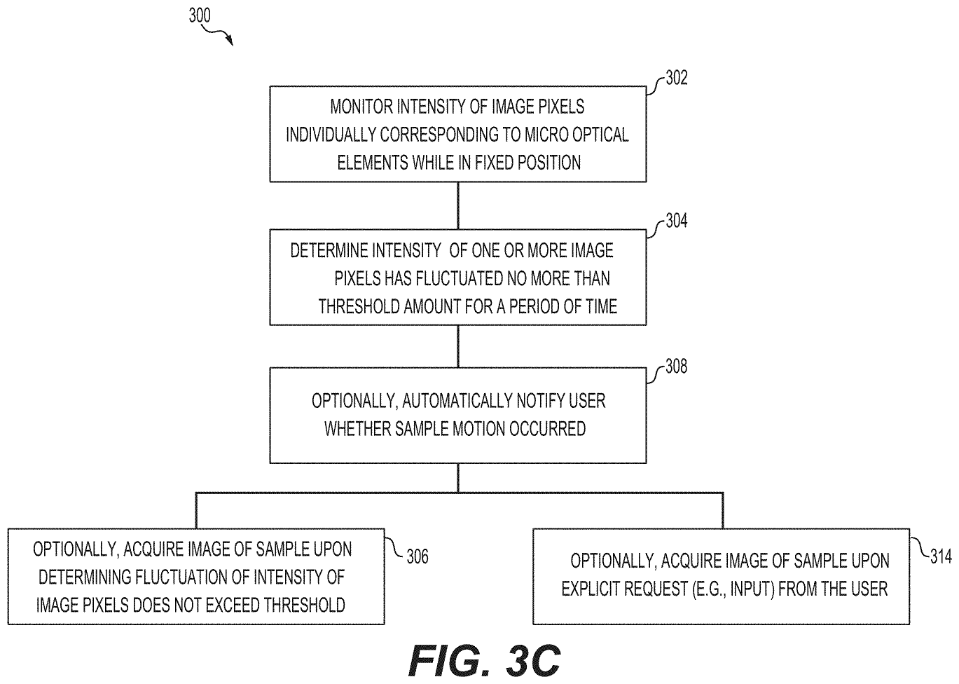

FIGS. 3A-C are process diagrams of methods 300 for determining whether a sample has moved. In step 302, image pixels individually corresponding to micro optical elements in an array of micro optical elements are monitored while the micro optical elements remain in a fixed position. Intensity of the image pixels is based on the amount of back-emitted light received by a detector that has been collected through the corresponding micro optical element. In step 304, it is determined whether sample motion has occurred, which in this example is determined based, at least in part, on whether fluctuation of intensity of the image pixels was no more than a threshold amount for a period of time. In some embodiments, multiple image pixels are monitored simultaneously (e.g., each corresponding to a respective micro optical element in an array of micro optical elements, for example wherein the respective micro optical elements are at least a quarter, at least half, or all of the micro optical elements in the array) to determine whether sample motion has occurred. Determining whether sample motion has occurred may be based, at least in part, on fluctuation of each respective image pixel not exceeding a threshold amount; on an average intensity fluctuation of the respective image pixels not exceeding a threshold amount; or on fluctuation of an average intensity of the respective image pixels not exceeding a threshold amount. The period of time may correspond to an acquisition time of a full image to be acquired. In optional step 306, an image of the sample is acquired (e.g., automatically) upon determining that fluctuation of intensity of the image pixel(s) does not exceed the threshold amount for the period of time. In optional step 308, a user is notified (e.g., automatically) (e.g., via a graphical user interface, e.g., a pop-up notification) whether sample motion has occurred based on the determination in step 304. A system may notify a user about the stabilization state of the sample to support the user in deciding when best to launch an image acquisition. In some embodiments, a user may be notified via a single event automatically triggered when sample motion meets a predetermined rule (e.g., when sample motion has become sufficiently small not to produce visible motion artifacts in the full image to be acquired). In some embodiments, a user is continuously notified of the current state of sample motion via a continuously updated indicator (e.g., graphical or text indicator), that may be reduced to a single scalar for the entire sample (e.g., a single color or symbol if graphical or a single value (e.g., measure) if text). In some embodiments, a user is continuously notified of the current state of sample motion via a continuously updated indicator array, that locally represents the state of sample motion (e.g., displayed as a color-coded miniature map of the sample).

In some embodiments of method 300, as shown in FIG. 3B, in step 310 intensity is used to determine whether a sample has locally moved by more than a threshold amount for a period of time. In step 312, a user is informed that the sample has moved more than the threshold amount. In step 314, an image is acquired upon an explicit request from the user. In application contexts under high time-pressure, a user may want to be empowered with the ability to launch an acquisition at any moment (s)he feels appropriate (e.g., based on a continuous notification of the current state of sample motion).

FIG. 3C shows an additional illustrative process flow for method 300.

In some embodiments, an image of a sample is acquired (e.g., automatically, e.g., without user input) upon determining that intensity of one or more image pixels has fluctuated no more than a threshold amount for a period of time. In some embodiments, the threshold amount is a predetermined (e.g., predefined) threshold amount and the method comprises predetermining the threshold amount based on a resolution (e.g., a selected resolution) of the image to be acquired before beginning the monitoring. In some embodiments, the threshold amount is a predetermined (e.g., predefined) threshold amount and the method comprises predetermining the threshold amount based on one or more characteristics of the sample. In some embodiments, a threshold amount is no more than 20% or no more than 10%. Generally, as sample motion slows or stops, intensity fluctuations will be reduced because there are generally no sharp discontinuities in intensity between adjacent pixels and pixel drift due to sample motion will slow. Using absolute threshold amounts of no more than 20% or no more than 10% may be sufficient, in some embodiments, to reduce or eliminate noticeable sample motion artifacts from a subsequently acquired image. In some embodiments, the period of time is at least 2 s and no more than 90 s or at least 0.1 s and no more than 2 s (e.g., at least 0.25 s and no more than 1 s). In some embodiments, the period of time is at least 5 s and no more than 30 s.

Monitoring intensity of image pixel(s) may include making discrete measurements of back-emitted light received over separate short periods. For example, intensity at a first time may be based on back-emitted light received at a detector (e.g., a CCD or CMOS camera) through micro optical element(s) for a first short period (e.g., no more than ten milliseconds, no more than five milliseconds, no more than three milliseconds, no more than two milliseconds, or less than a millisecond) and intensity at a second time may be based on back-emitted light received at the detector through the micro optical element(s) for a second short period that is an equal length of time to the first short period. There may be a period of delay between the first short period and the second short period (e.g., of at least 1 ms and no more than 1 s or no more than 100 ms). A longer period of delay will generally mean that a method is more sensitive to movement, though also reduces the actual or potential time savings as compared to simply waiting for sufficient time to ensure sample stabilization (e.g., equilibration). Additionally, longer periods of delay may cause user confusion when viewing a graphical output of the monitoring, if provided. Therefore, in some embodiments, a period of delay is in a range of from 0.25 s-0.75 s (e.g., about 0.5 s). In some embodiments, a period of delay is no more than 5 s (e.g., no more than 3 s, no more than 2 s, or no more than 1 s).

Determining whether a sample has moved may include processing (e.g., comparing) the intensity at the first time to the intensity at the second time. In some embodiments, the period of delay needs to be carefully chosen. If the period of delay is too small, small motions of the sample may not be perceptible at this time scale, while yet resulting in visible motion artifacts in the full image that is acquired afterwards. On the other end, if the period of delay is too large, motions of the sample that have occurred early in the observation period will lead to believing that the sample still is in motion, even though it may have stabilized in the meantime, thus resulting in a waste of time. By selecting a period of delay that allows a “real time” frame rate of images to be provided to a user, the user can observe fluctuations as they occur to make a determination whether the sample is stabilizing or has stabilized. Fluctuations of intensity over time may be based on discrete measurements of intensity made at a set of times during the monitoring.

Intensity fluctuations may be calculated simply by taking the absolute value of the difference in intensity of a pixel at two moments in time separated by a period of delay. Such an approach provides only sparse sampling and may therefore not be sensitive to intensity fluctuation that has occurred between the two sampled moments in time (e.g. the intensity may have changed and returned to more or less the same value). Intensity fluctuations may be calculated more sensitively by recording the image pixel value (representing sample light intensity for a micro optical element) at multiple moments in time and by taking the intensity difference between the maximum and the minimum values recorded over a period of time. Such an intensity fluctuation metric may also be normalized by dividing it by the time elapsed between the maximum and the minimum values. Intensity fluctuation may be calculated more sensitively by recording the pixel value at multiple moments in time and by taking the cumulative absolute difference in intensity between all successive values recorded over a period of time. Such an intensity fluctuation metric may be normalized by dividing it by the period of delay over which it is calculated. This approach has the advantage of being more sensitive to sample motions causing value of an image pixel (representing intensity of sample light for a micro optical element) to vary non-monotonously in time. It has, however, the drawback of being also more sensitive to noise in intensity signals. It may therefore be desirable to smooth the intensity signals, e.g. with a moving average filter, before calculating the intensity fluctuation in this way. For example, for intensity values recorded continuously, some 1-5 ms apart, averaging (e.g., with a moving window filter) over at least 25 values may be desirable.

When monitoring the pixel value of a single image pixel, it is relatively likely, depending on the nature of the sample, that there is no tissue structure of sufficient spatial frequency modulation and/or contrast in pixel to provide enough sensitivity on sample motion. It may thus be advantageous to consider multiple image pixels when assessing whether sample motion has occurred or is occurring. For example, a unique intensity fluctuations metric may be calculated for an area that is made up from multiple image pixels (e.g., the intensity fluctuation in each pixel of a region of image pixels may be averaged to give a mean intensity fluctuation for those pixels). These regions may be constructed from isotropic binning of image pixels (e.g., grouping 2×2 image pixels, 3×3 image pixels, 4×4 image pixels, 6×6 image pixels, 8×8 image pixels, 16×16 image pixels) of from anisotropic binning (e.g., 1×2 image pixels, 3×4 image pixels, 6×8 image pixels, 1×12 image pixels). As sample motion sometimes is localized to a relatively small area, it may be counterproductive to combine too many image pixels together in a given area, especially if the pixels are located relatively far away from one another.

### Live View Mode

In some embodiments, a method provides live sample monitoring information to a user. In some embodiments, such a method includes generating, and optionally also displaying, one or more images in real time where the image(s) are generated based on sample light received from micro optical elements in a micro optical element array without scanning the array or the sample. Thus, the image(s) can be generated as soon as the light is received as there is no need to receive light from multiple positions in a scan pattern before the image(s) can be generated. This approach can substantially reduce the time needed to receive enough signal to generate an image.

In certain embodiments, sufficient intensity of light to generate a useful image can be received from micro optical elements at a detector in an exposure time of <250 milliseconds (ms), enabling a frame rate of images that can be generated and displayed to a user of at least 4 frames per second. (For some users, a frame rate of at least 4 frames per second is necessary to respond to changes in sample position, motion, and/or stability in real time.) Shorter exposure time (e.g., <10 ms, <5 ms, or <2 ms) can enable higher frame rates that provide a user with information in a manner that is more sensitive to, for example, sample motion. Shorter exposure time also means that each image corresponds to a more instantaneous “snapshot” such that comparison of such images can provide a more sensitive assessment of sample motion that may be occurring. Sample light received from micro optical elements while they remain in a fixed position during an exposure time can be detected at a detector (e.g., a CMOS or CCD camera). Images can be generated that include image pixels representing relative intensity of the sample light received at detector element(s) corresponding to specific micro optical elements in the array over the exposure time in real time (an example of a “live view” mode). When a sample and a micro optical element array are fixed during imaging, each micro optical element in an array will image a different (e.g., distinct) location in the sample where the different locations are spatially separated by a characteristic distance for the micro optical element array (e.g., a pitch of micro optical elements in the array). Of course a given image pixel may represent a changing location of the sample over time if the sample is in motion (e.g., due to natural relaxation), presumably leading to fluctuations in intensity of the given image pixel between successive images.

In some embodiments, an imaging system may be designed and calibrated such that one micro optical element is imaged on exactly one detector element (e.g., when not scanning). In some such embodiments, detector frames (without further processing) already constitute images of the sample in which one pixel represents the signal from a unique and different micro optical element in the micro optical element array. In some embodiments, one micro optical element is imaged over many detector elements (e.g., on >4, >9, >16, >25, >100 detector elements). For example, a micro optical element array may have on the order of tens of thousands of micro optical elements while a correspondingly sized detector may include millions or tens of millions of detector elements (e.g., be a 10+ megapixel camera). In some such embodiments, intensity collected by a unique micro optical element may be calculated from values of the many detector elements over which this micro optical element is imaged (e.g. by summing or interpolating the detector element values), so as to generate an image in which one image pixel represents the signal from a unique and different micro optical element as determined from multiple detector elements. An image pixel may represent a sum or average of intensity of sample light received at the detector elements corresponding to a specific micro optical element.

Generally, higher optical resolution of micro optical elements will make a live view mode more sensitive. In some embodiments, optical resolution of micro optical elements are preferably substantially equal to (e.g., within 10%) or smaller than sample structures (e.g., tissue sample micro structures), for example preferably have lateral point spread function <10 μm, <5 μm, <2 μm, or <1 μm. With smaller optical resolution, the spatial resolution of image pixels in an image generated when not scanning is enhanced, which will tend to show motion or stabilization occurring more clearly and provide a user with a better understanding of a current state of a sample when observing in a live view mode.

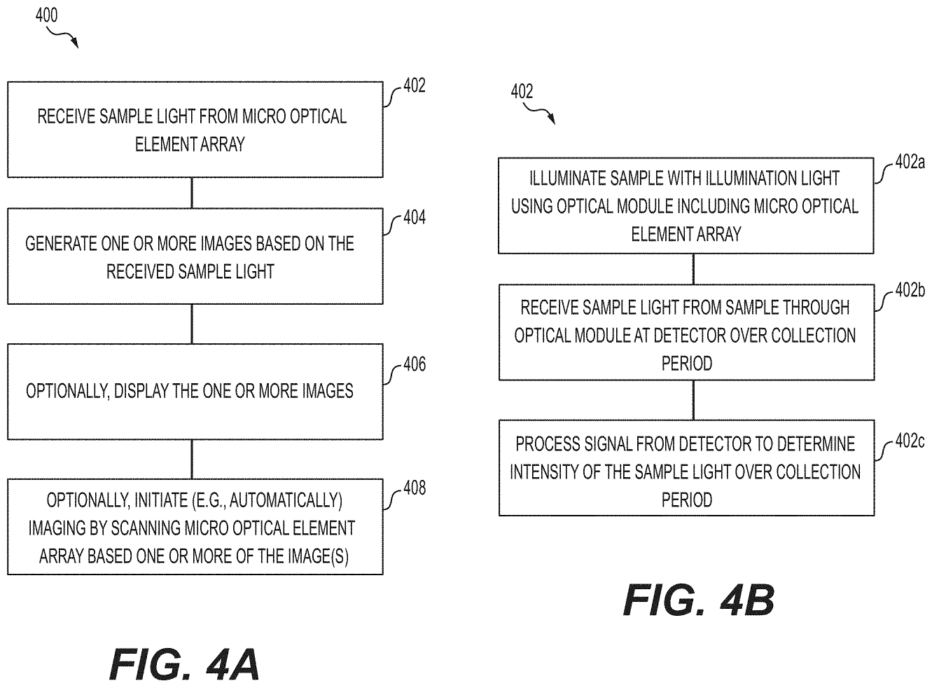

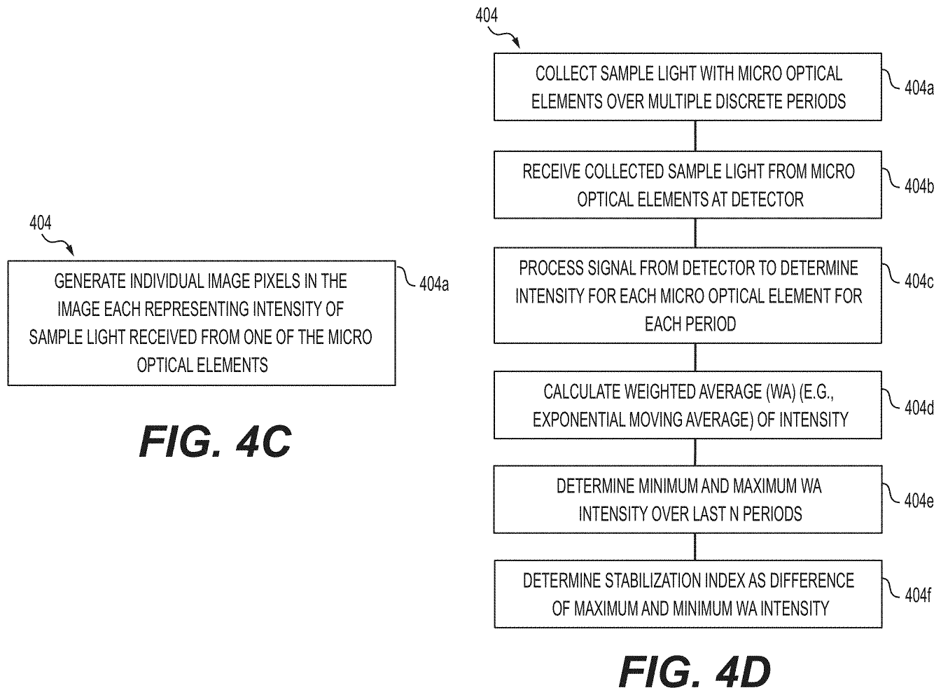

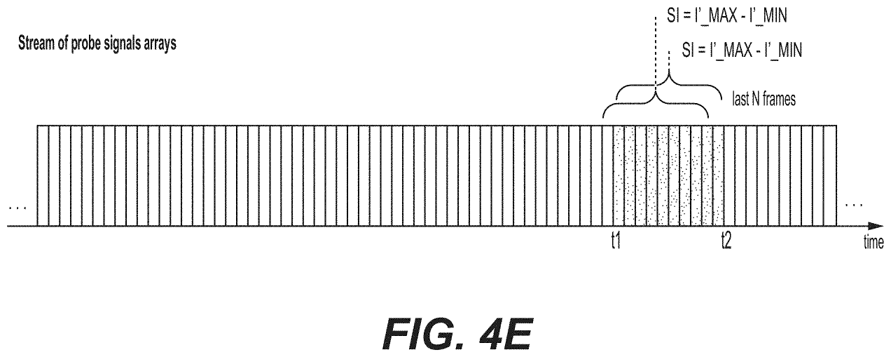

FIGS. 4A-4C show an example method 400 for generating, and optionally displaying, one or more images to provide live sample monitoring information to a user. In step 402, sample light is received from a micro optical element array. Referring to FIG. 4B, step 402 may include substep 402a of illuminating a sample with illumination light using an optical module comprising an array of micro optical elements; step 402b of receiving sample light from the sample from the micro optical element array (e.g., through the optical module) at a detector over a period of time; and step 402c of processing signal from the detector to determine intensity of the sample light over the collection period (e.g., a detector frame captured with a given exposure time). Referring back to FIG. 4A, in step 404, one or more images are generated, in real time, based on the sample light received from the micro optical elements. For example, the one or more images can be generated in step 404 while substeps 402a-402c are performed for new sample light from a new period of time such that sample light is (nearly) continuously being received and processed. FIG. 4C illustrates an example subroutine of step 404 including substep 404a of generating individual image pixels in each image, each of the image pixels representing intensity of the sample light received from one of the micro optical elements at the detector (e.g., at one or more respective detector elements). Referring back to FIG. 4A, in step 406, the one or more images are optionally displayed. Step 406 may occur concurrently with step 402 and/or step 404. In step 408, imaging that includes scanning the micro optical element array is initiated (e.g., automatically) based on one or more of the one or more images. For example, if one or more of the images indicates (e.g., to a user or as determined by an image processing or recognition algorithm) that the sample is sufficiently stabilized (e.g., over a period of time) then imaging by scanning may be initiated. A sample may be quantitative determined to be sufficiently stabilized based on a stabilization index (e.g., as discussed in subsequent paragraphs), having a certain sufficiently large area that is in focus (e.g., and not changing appreciably, such as by more than 10% over a period of time), and/or not containing any bubbles (e.g., over a period of time).

Generating one or more images may include calculating an absolute number and/or proportion of micro optical elements returning sample light above a pre-determined intensity threshold. If a micro optical element returns sample light below the threshold, then a corresponding image pixel may have a zero pixel value. If it returns sample light above the threshold, then a corresponding image pixel may have a non-zero pixel value. Detecting area in an image corresponding to background (e.g., image area in which no sample area is in focus) (e.g., with Laplacian based operators) and calculating the absolute number and/or proportion of micro optical elements not facing background may be part of determining and displaying size of an imaged surface of a sample face. In some embodiments, a micro optical element may return no sample light or sample light below a detection threshold for a detector such that a corresponding image pixel has zero pixel value.

FIGS. 5A-5D illustrate an example use of a live view mode of a sample accomplished according to methods disclosed herein. In this example, sample area that is in focus is monitored with a live view mode. Each image pixel represents intensity of light received from an individual micro optical element in an array for a distinct location in a sample over a short period of time (e.g., 1-3 ms) prior to image generation. The region defined by the dashed outline shows a zero pixel value for all image pixels in the region (representing no sample light collected and therefore no sample light received for in an area of the sample corresponding to that region of the image) at to (shown in FIG. 5A). Zero pixel values for image pixels may indicate that a sample is not in focus in the area corresponding to those image pixels (e.g., with light that would have been detected at corresponding detector element(s) having been filtered out with aperture(s)). At subsequent successive times, shown in FIGS. 5B-5D, the area that is in focus increases resulting in progressively more of the region defined by the dashed outline being filled in over time. Thus, over time, a progressively larger area of image pixels have non-zero pixel values and a convex hull of the image pixels having non-zero pixel values grows at an increasingly slower rate. The sample may be considered to have sufficiently large area that is in focus (e.g., to warrant initiating imaging by scanning) in one or more images based on the area of image pixels having non-zero pixel values and/or a rate of change in the convex hull. The increasing area that is in focus shown over the time series of FIGS. 5A-5D may be the result of a user adjusting (e.g., manipulating) the sample to reposition it to have area that is in focus. FIGS. 5A-5D are greyscale images comprising image pixels that represent a range of intensities of sample light received from micro optical elements for different locations in a sample.

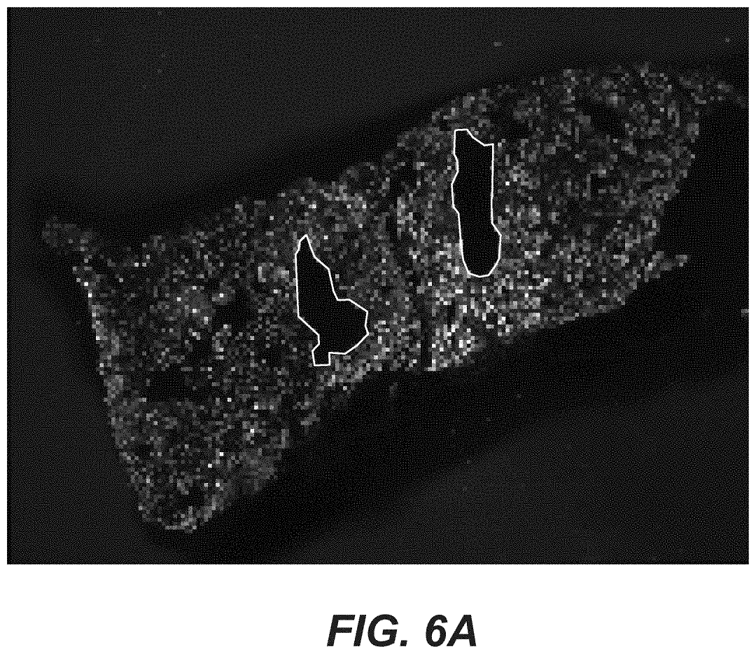

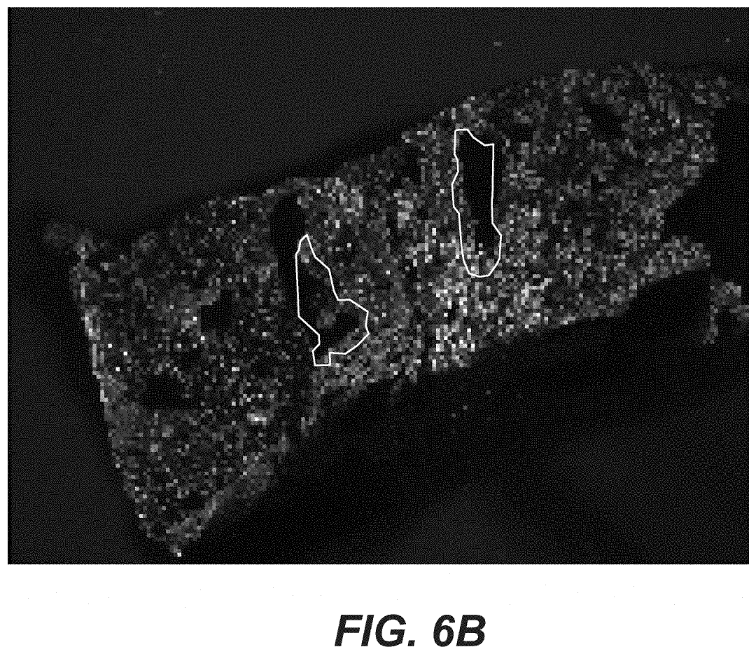

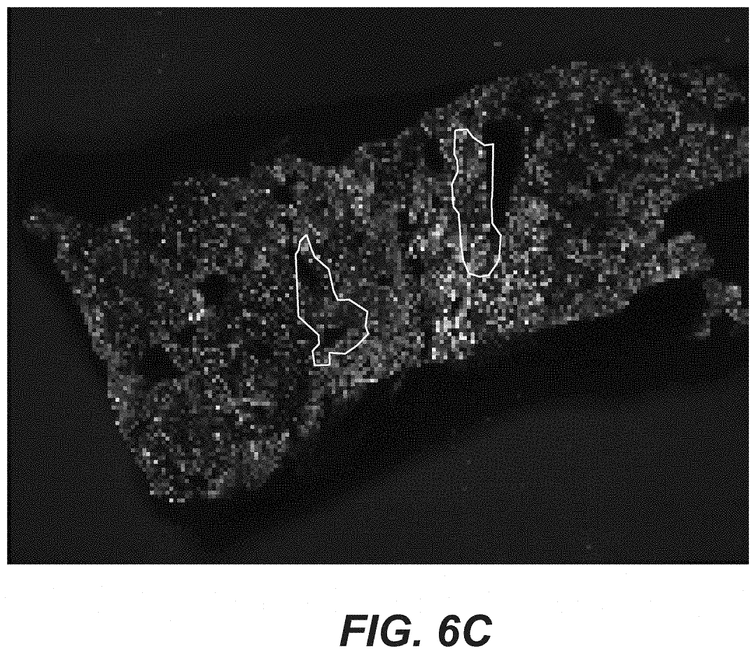

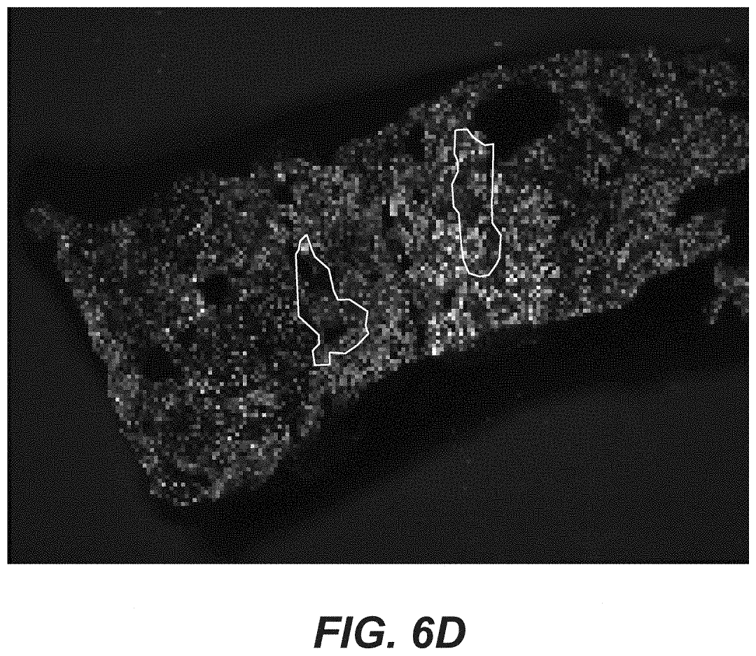

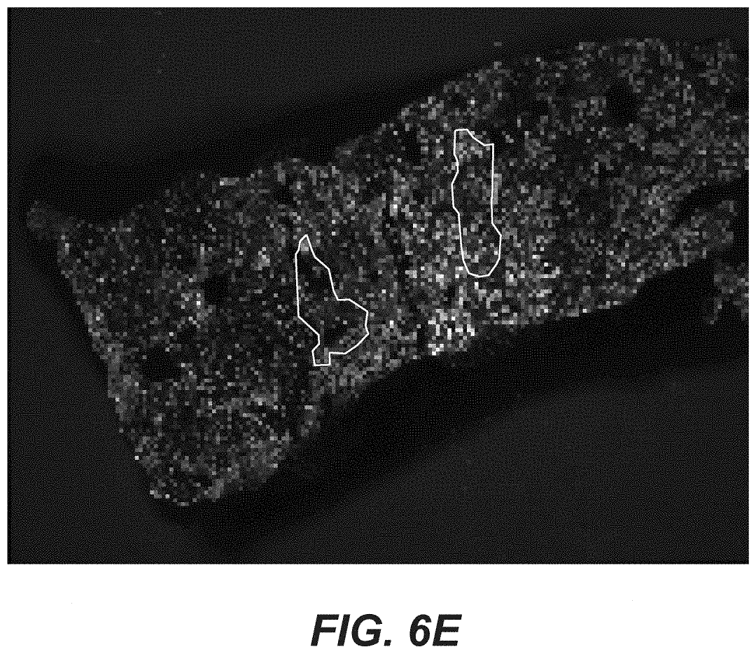

FIGS. 6A-6E illustrate an example use of a live view mode of a sample accomplished according to methods disclosed herein. In this example, a live view mode is monitored to determine whether bubble(s) are present in the sample. Each image pixel represents intensity of light received from an individual micro optical element in an array for a distinct location in a sample over a short period of time prior to image generation. The region defined by the dashed outline shows a zero pixel value for all image pixels in the region (representing no sample light collected and therefore no sample light received for in an area of the sample corresponding to that region of the image) at to (shown in FIG. 6A). Such image pixels having zero pixel values being surrounded (e.g., at least partially) by image pixels having non-zero pixel values indicates the presence of a bubble. In FIG. 6A, two bubbles are present, each indicated by a white outline that highlights a perimeter of an area of image pixels having zero pixel values, the perimeter being defined by image pixels having non-zero pixel values (e.g., wherein at least 70% of the image pixels on the perimeter have non-zero pixel values). An image processing or recognition algorithm may be applied to automatically determine whether any such regions are present in an image or present over time (e.g., in a plurality of images). Over time, as shown in FIGS. 6B-6E, the live view mode shows shifting, shrinking, and eventual disappearance of areas of image pixels having zero pixel values surrounded by a perimeter comprising predominately (e.g., at least 70%) image pixels having non-zero pixel values. A user may consider the sample ready for imaging by scanning once the live view shows no remaining bubbles or require, inter alia, no bubbles to be present before imaging by scanning. In some embodiments, a processor may automatically determine (e.g., using an image processing or recognition algorithm) that no bubble is present. An area threshold (e.g., set by a user) may be used to distinguish bubbles from regions of a sample that would never result in image pixels having non-zero pixel values (e.g., that are not fluorescently tagged). FIGS. 6A-6E are greyscale images comprising image pixels that represent a range of intensities of sample light received from micro optical elements for different locations in a sample.

Images with Stabilization Indices

Live view modes, as disclosed in the preceding paragraphs, allow a user to see real time sample information that can be used to monitor, among other characteristics of a sample, sample positioning and sample motion and (self-)stabilization. Generally, in a live view mode, samples that are moving more, whether due to relaxation or other mechanisms, will appear to have more fluctuation in intensities of image pixels over a period of time. An experienced user may be able to determine when such fluctuations are sufficiently small as to indicate that a full image subsequently acquired by scanning a micro optical element array over a scan pattern will be of sufficiently high quality (e.g., sufficiently devoid of sample motion artifacts) to be useful (e.g., in determining whether one or more features, such as one(s) indicative of cancer, are present in the image). However, inexperienced users, or even some experienced users, may not have, or be able to develop, such a skill. Therefore, it is advantageous, in certain embodiments, to present a quantitative assessment of sample stabilization over a period of time: a stabilization index.

A stabilization index, or stabilization indices, may be presented to a user by a graphical indication (e.g., icon, shading, graphic, or color) on an image. Thresholding may be applied to calculated stabilization indices for different image pixel regions to allow for images to be shaded or colored to be easy to interpret by a user (e.g., using a null, yellow, red or null, yellow, orange, red color scheme). Using graphical indications of one or more stabilization indices, a user may be able to easily interpret an image to decide when to initiate imaging. Such a decision may also be made automatically by a processor using stabilization index values for one or more images.

Many different stabilization indices may be calculated, and presented to a user with graphical indication(s), to provide a quantitative assessment of sample stabilization. In some embodiments, an overall stabilization index for each image is calculated. In some embodiments, a stabilization index is calculated for each of a subset of the images pixels (e.g., each image pixel in a region of image pixels) in an image. In some embodiments, for at least a portions of the micro optical elements in an array, a stabilization index is determined by comparing changes in intensity of sample light received from a micro optical element over an period of time. Since intensity of sample light received from a micro optical element may change non-uniformly over a period of time and since signal from sample light used in a determination of a stabilization index may correspond to different periods of time at different instances (e.g., using a moving period of time of fixed duration), a stabilization index may be dynamic/change over time (e.g., change between successive images).

Referring to FIG. 4A, in some embodiments, a step 404 of generating one or more images based on sample light received from micro optical elements in an array without scanning may include performing the subroutine shown in FIG. 4D to calculate a stabilization index. In step 404a, sample light is collected over multiple discrete periods (e.g., successive periods with one ending as another begins) with a micro optical element array. In step 404b, the collected sample light is received from the micro optical element array at a detector. In step 404c, signal from the detector is processed to determine intensity for each micro optical element for each period. That is, a series of detector frames are captured using the micro optical element array, one frame for each period. In step 404d, a weighted average (e.g., an exponential moving average) of the intensity is determined using the detector frames. Eqns. 1 and 2 give an example of calculating an exponential moving average.

I′(m,t)=I(m,1) for t=1 (i.e. for the first frame) (eq. 1)

I′(m,t)=α*I(m,t)+(1−α)*I′(m,t−1) for t>1 (i.e. for every subsequent frame) (eq. 2)

α is a user set parameter between 0 and 1, for example 0.1. The number of detector frames used in determining a weighted average and/or a stabilization index may be a user settable parameter, N, as well. In step 404e, a minimum (I′ₘᵢₙ(m)) and a maximum (I′ₘₐₓ(m)) weighted average intensity is calculated for each micro optical element m over a period of time, e.g., the last N detector frames. A stabilization index can then be determined in real time as the difference between I′ₘₐₓ(m) and I′ₘᵢₙ(m) (S=I′ₘₐₓ(m)−I′ₘᵢₙ(m)), in step 404f. FIG. 4E provides a visual demonstration of such a calculation.

While one specific example of a stabilization index was elaborated in the preceding paragraph, changes in intensity can be determined using different formulas, including one or more of differences, ratios, floors, and ceilings. A weighted time-average, such as a weighted exponential average, may be used to calculate a stabilization index. Moreover, the stabilization index determined corresponded to an individual micro optical element in an array, e.g., was for an individual image pixel. Providing individual stabilization indices for each of the image pixels does not make image interpretation (e.g., by a user) any easier than a normal live view mode. Therefore, in some embodiments, stabilization indices for a region of image pixels (corresponding to a cluster of micro optical elements) are determined. An easy to interpret graphical indication (e.g., icon, shading, graphic, or color) can then be included in an image that indicates the stabilization index for the micro optical elements corresponding to that region. A cluster can be of at least 9 micro optical elements (e.g., at least 16 micro optical elements, at least 25 micro optical elements, at least 49 micro optical elements, or at least 64 micro optical elements). The indication can be based on, for example, a minimum, maximum, or average stabilization index for sample light received from the micro optical elements in the cluster.

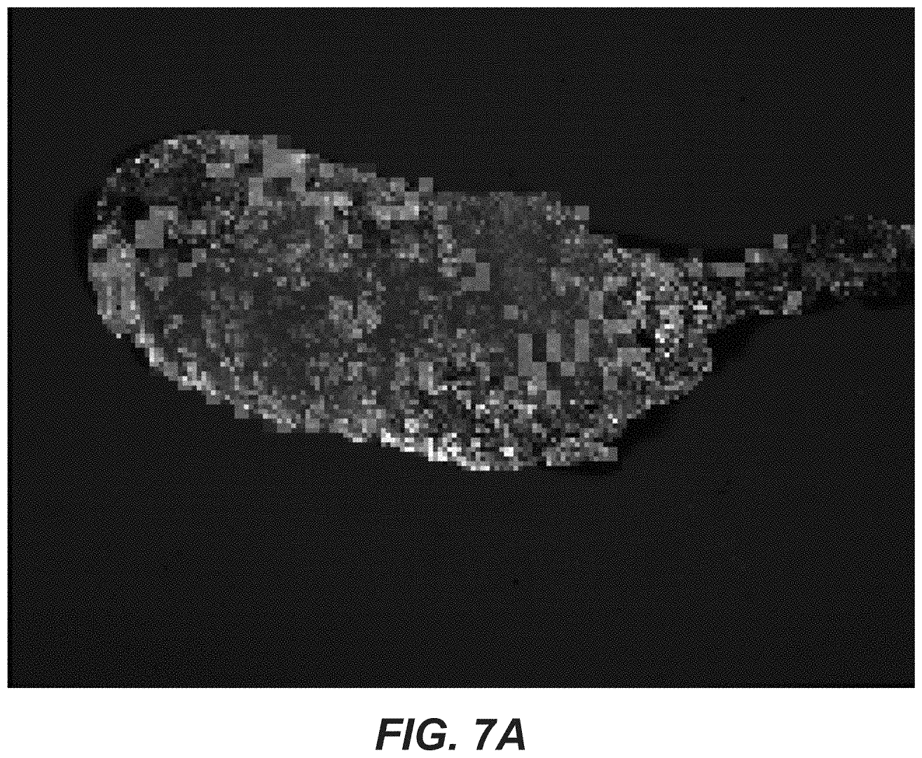

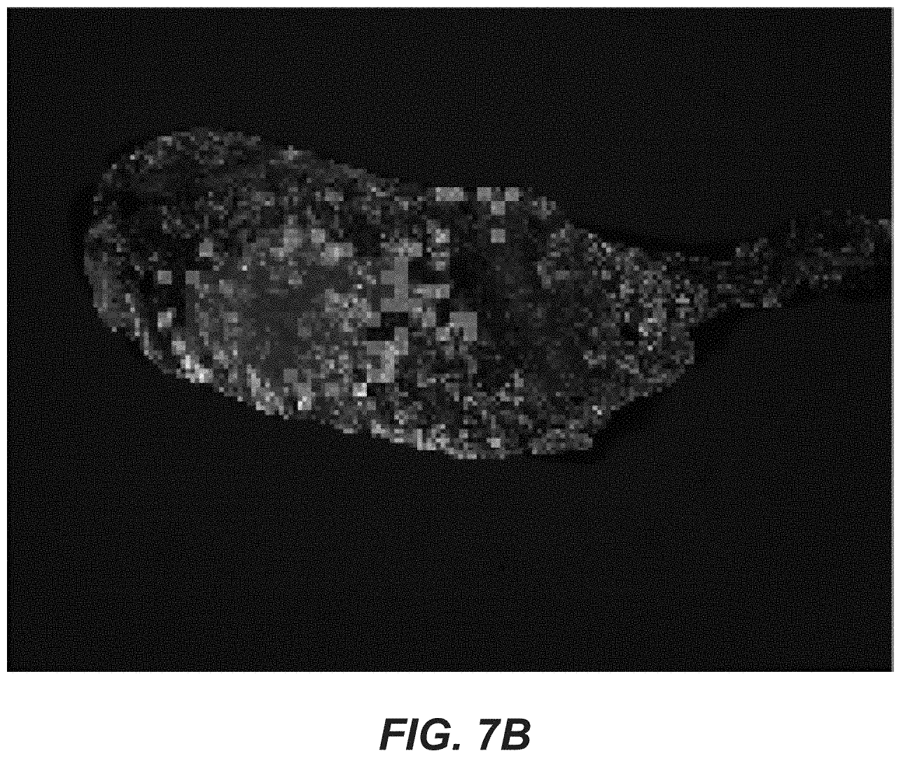

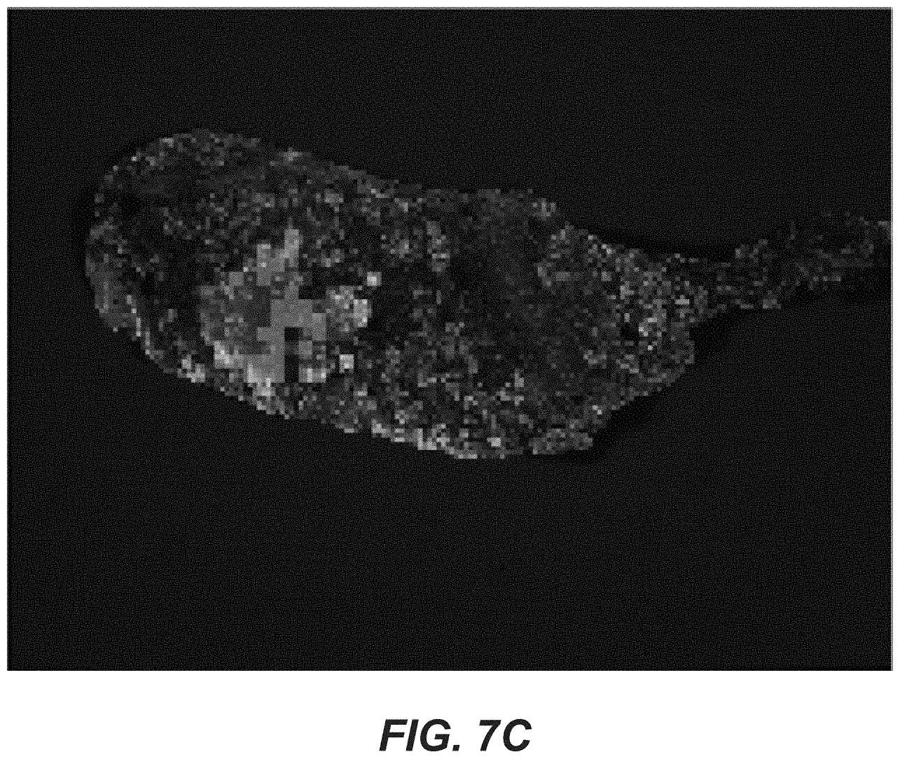

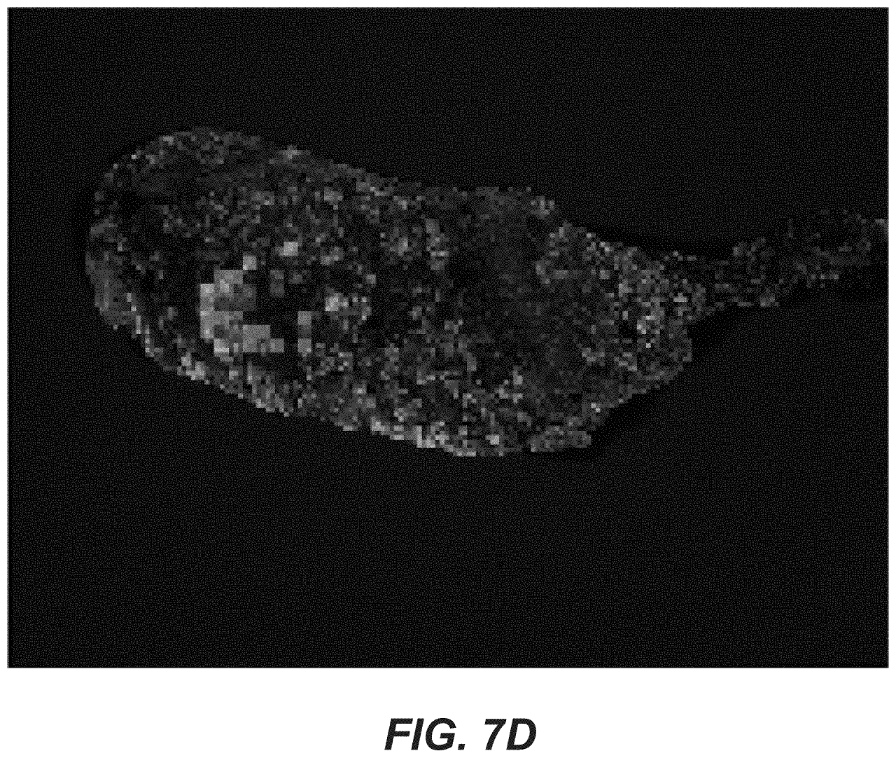

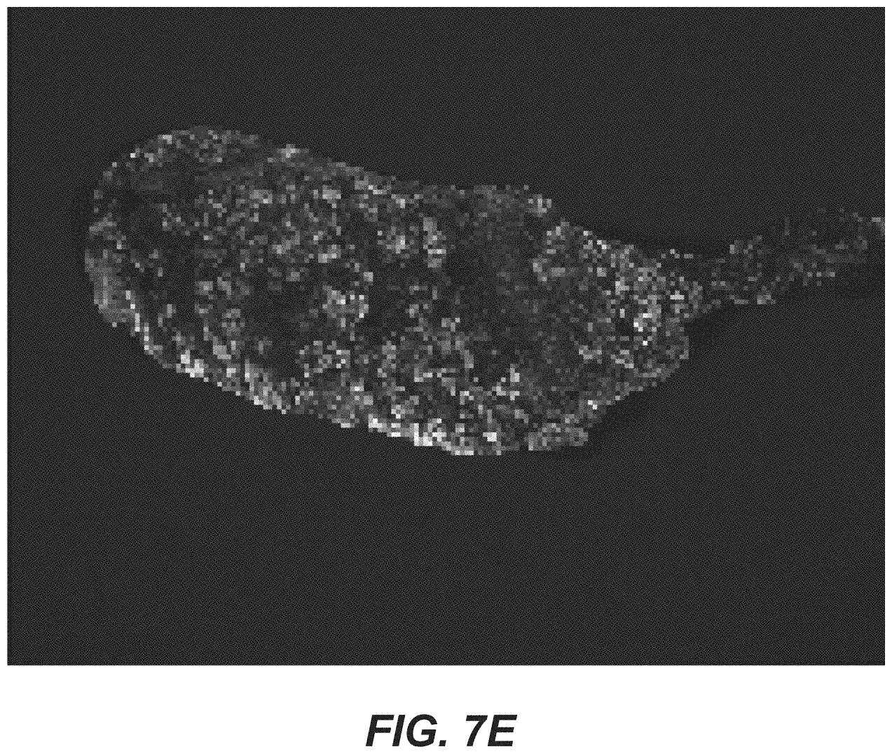

FIGS. 7A-7D show an example of images generated and displayed to a user for a sample with a semi-transparent stabilization index overlay, wherein indications of the stabilization index are for regions of the image pixels. The stabilization index is overlaid over a live view mode but, in some embodiments, an image comprises only an indication of calculated stabilization indices (without any live view mode). In FIG. 7A (at arbitrarily assigned to), much of the sample is in motion (has low stabilization) as evidenced by the large fraction of image pixel regions that have a semi-transparent red overlay due to a high stabilization index value (and therefore indicative of relatively large sample motion), calculated by determining changes in intensity of sample light received over a period of time for those locations. At the periphery of the high motion region are some small areas with a moderate amount of sample motion as indicated by the semi-transparent yellow overlay. Regions of image pixels with yellow indications correspond to areas of the sample with relatively more stabilization and therefore lower stabilization index values than regions of image pixels with red indications. In the successive images of FIGS. 7B (at t₁), 7C (at t₂), and 7D (at t₃), the sample increasingly stabilizes resulting in progressively lower stabilization index values for progressively more areas of the sample and therefore fewer and fewer regions of image pixels with red and yellow indications overlaid (fewer and fewer clusters of micro optical elements receiving sample light changing appreciably—indicative of decreasing sample motion). Even if a user is unable to determine whether pixel value fluctuation for image pixels is appreciably declining over time in the live view mode, the graphical indications in FIGS. 7A-7D are easy to interpret. A sample at or shortly after t₃ could be imaged by scanning a micro optical element array with few, if any, sample motion artifacts being present. FIG. 7E shows a live view mode of the sample without a stabilization index mode overlay (e.g., immediately prior to imaging by scanning a micro optical element array).

### Displaying Images

In some embodiments, images are displayed as they are generated, in real time. In some embodiments, images are automatically processed by an image processing or recognition algorithm and, accordingly, may not also be separately displayed, at least not in real time. Images that are displayed may be displayed in one or more graphical user interfaces. One or more graphical user interfaces may allow for user input that alters images. For example, a user may be able to show or hide a stabilization index view (e.g., overlay), show or hide summary statistics for one or more stabilization indices for image(s), or show or hide a live view mode.

In some embodiments, it may be preferred to hide a stabilization index view (e.g., overlay), when positioning a sample. During positioning, a sample moves significantly which would result in very high stabilization index values over a large area of the sample (e.g., over the entire sample). Accordingly, a stabilization index view would not provide useful information during that time and may actually be disturbing to a user who is trying to determine how a sample is positioned. Therefore, a computing device (e.g., comprised in an imaging system) may hide (e.g., due to user input) a stabilization index view during a sample positioning period and then subsequently enable the stabilization index view (e.g., due to further user input) in order to track sample stabilization after positioning is complete. Image acquisition using a scan pattern (e.g., of a micro optical element array) may be initiated (e.g., automatically) once one or more image stabilization indices indicate sufficient stabilization has occurred.

One or more graphical user interfaces (e.g., used to display generated images in real time to a user) may be provided to allow a user to provide various inputs. In some embodiments, a graphical user interface allows a user to provide parameters used to calculate a stabilization index (e.g., weighting parameter(s) for a weighted average) for image pixels. In some embodiments, a graphical user interface allows a user to provide input to tag an image or images from a live view mode or stabilization index view (e.g., overlaid over a live view mode) with location and/or orientation information. In some embodiments, a graphical user interface allows a user to provide input for thresholding a stabilization index (e.g., specific threshold stabilization index values to act as thresholds, bin size, or characteristics of indications (e.g., colors and/or transparencies)). In some embodiments, a graphical user interface allows a user to adjust brightness and/or contrast of image(s) being generated and/or displayed in real time. In some embodiments, a graphical user interface allows a user to select (e.g., toggle) between a greyscale view and a false color view (e.g., mimicking a histologically stained sample, e.g., showing shades of purple) for a live view mode.

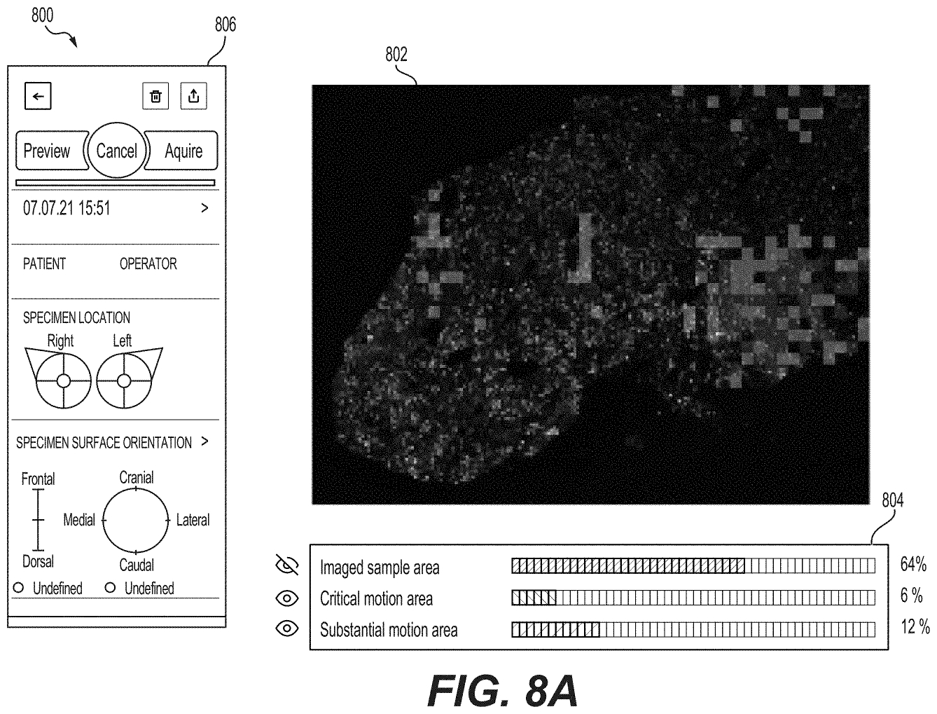

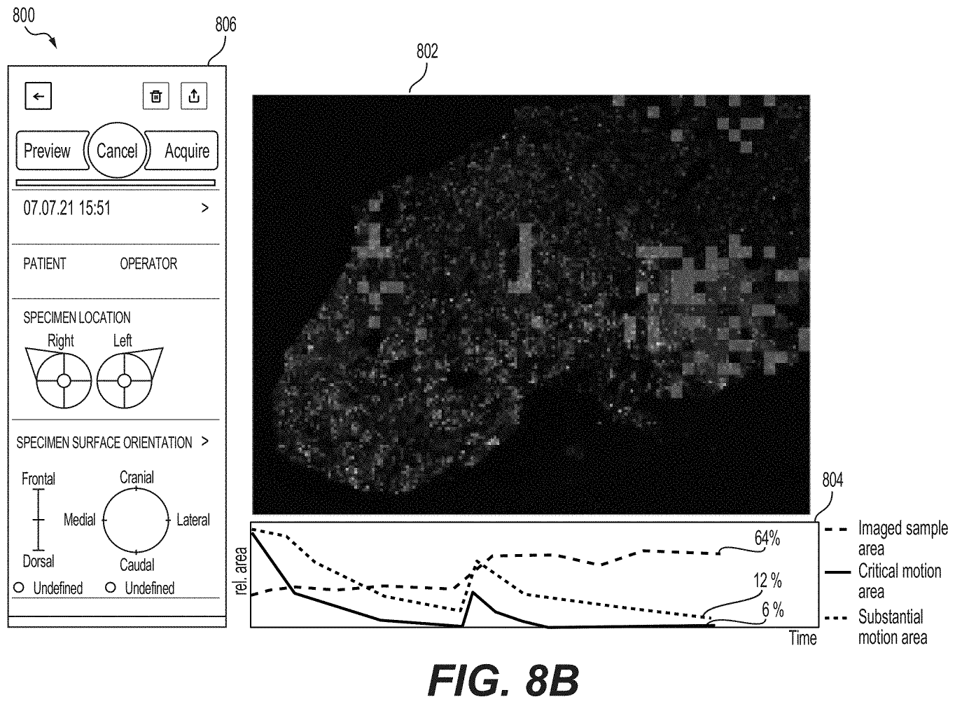

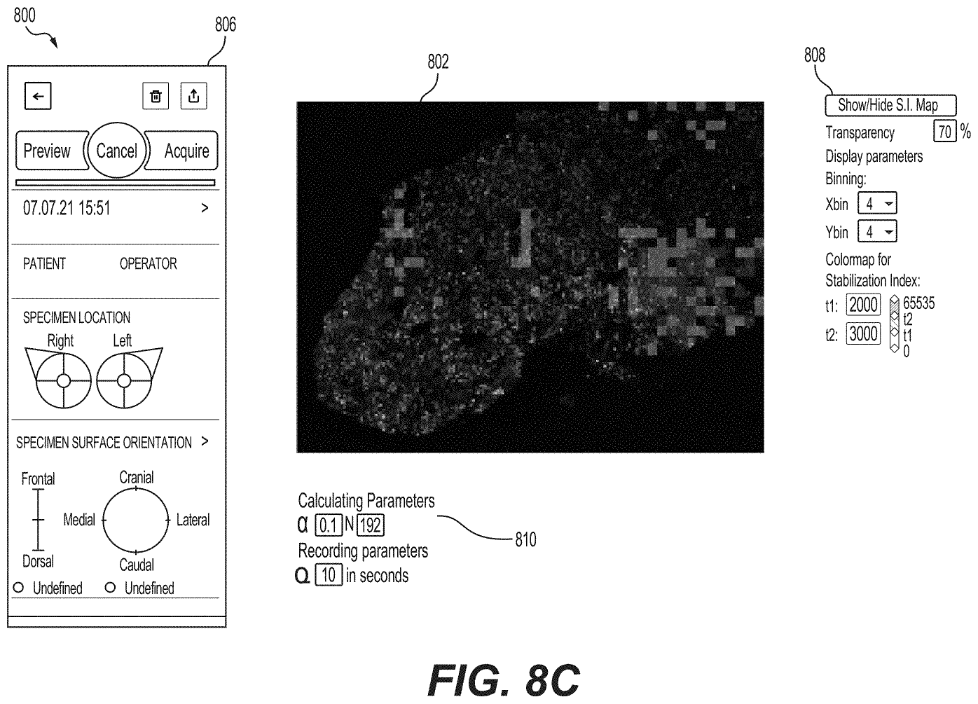

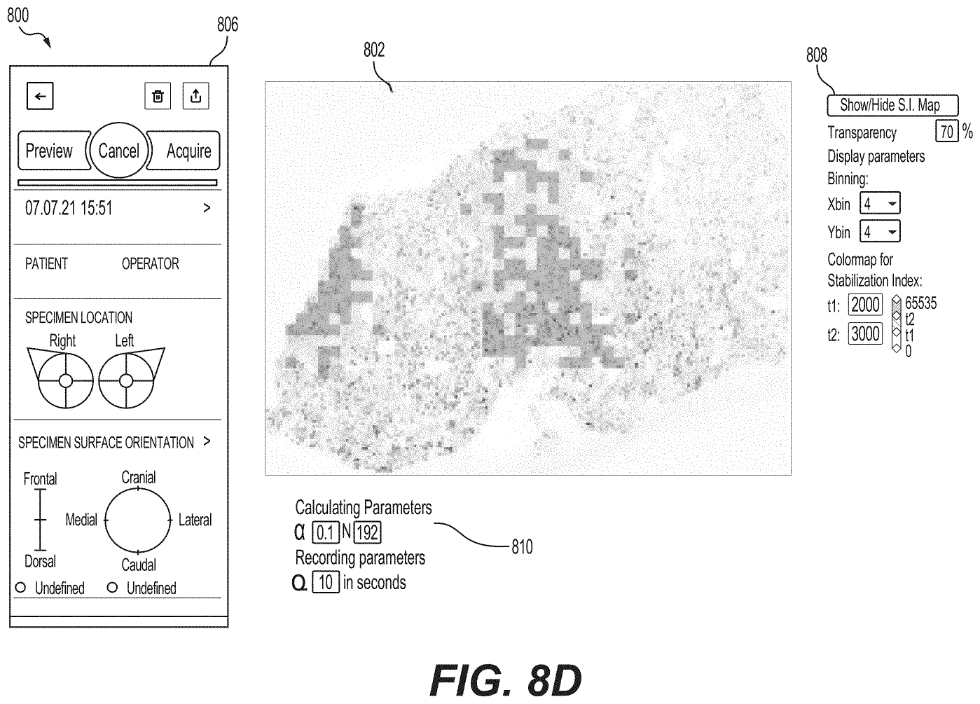

FIGS. 8A-8D show examples of graphical user interfaces each including a live view mode of a sample with a stabilization index overlay. In the graphical user interface(s) FIG. 8A, image 802 is a greyscale image that represents fluorescence intensity of sample light received from micro optical elements in an array. Some image pixels are brighter and some are darker, showing a variation of the intensity over the exposure time used to collect the sample light. Image 802 also includes a stabilization index overlay illustrating that some sample motion is occurring at the time the image is generated and displayed, mostly on the right side of the image. User interface 804 shows summary statistics about image 802. The summary statistics include a percentage of imaged sample area (the percentage of total area available to be imaged with a fixed micro optical element array that is in focus and therefore imaged), a percentage of critical motion area (where sample motion is currently high—corresponding to a high stabilization index value), and a percentage of substantial motion area (where sample motion is notable but less so than in the critical motion area—corresponding to a medium stabilization index value). Interface 806 allows a user to tag location and/or orientation information to image 802 as well as start full image acquisition by initiating scanning of the micro optical element array. For example, a user may view image 802 and determine that the amount of sample motion indicated by the stabilization index overlay is sufficiently small that a high quality full scan image may be generated and therefore may click the “acquire” button to initiate scanning.

FIG. 8B is similar to FIG. 8A except that summary statistics are shown with time resolution so a user may easily observe trends in percentage of imaged sample area, percentage of critical motion area, and percentage of substantial motion area. Longer periods with smaller or minimal changes in these statistics would indicate better sample stabilization. In some embodiments, it is preferred that percentage of critical motion area and/or percentage of substantial motion area tend toward zero or are within a small amount (e.g., 1-5%) of zero prior to beginning full imaging by scanning.

FIG. 8C is similar to FIGS. 8A and 8B except that interfaces 808, 810 are provided to enable a user to input parameters used to generate image 802. Interface 808 includes inputs for parameters associated with the stabilization index overlay shown in image 802 and a button to show/hide the interface. Parameters that can be changed by a user include transparency of the indications (e.g., which may be altered by a user to make the underlying live view mode easier or harder to see) of the stabilization indices, binning (e.g., how big of a cluster of micro optical elements the regions of indication correspond to, currently set to 4×4), and threshold values for the stabilization index that determine which color (null, yellow, or red) to shade/color each (4×4) region. Interface 810 includes parameters used to calculate stabilization index values for the individual regions, including a weighting parameter and number of detector frames over which to determine the minimum and maximum intensity.

FIG. 8D is similar to FIG. 8C except that image 802 is not a greyscale image but rather one where image pixels of a live view mode included in image 802 have a false color, in this case purple, mimicking a histological stain.

Images generated from sample light received from a micro optical element array without scanning may include image pixels each representing a respective micro optical element in the array. Accordingly, as the number of micro optical elements in an array may be low relative to typical image resolutions, an image may be relatively low resolution. Images may be displayed to a user with a display (e.g., of an imaging system) that has a high maximum resolution (e.g., may be a 1080p or 4K monitor). Therefore, to make images reasonable physical size on a display, multiple display pixels may be used to display individual image pixels. As long as a uniform scaling is used, no distortion to the image will occur. Interpolation may be used, alternatively or additionally to scaling, to display an image on a high-resolution display.

### Computer Systems, Computing Devices, and Network Implementations

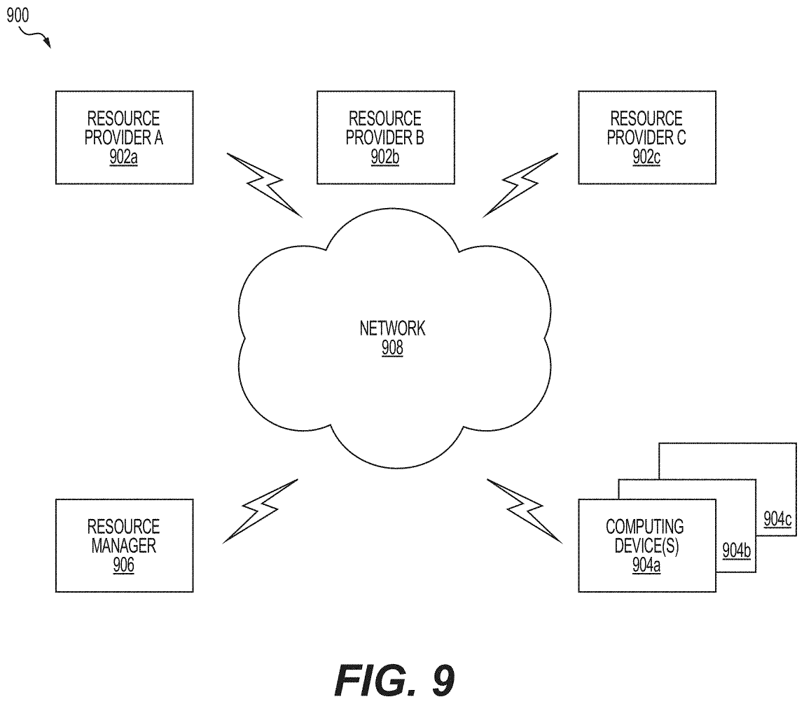

Illustrative embodiments of systems and methods disclosed herein were described above with reference to computations performed locally by a computing device. However, computations performed over a network are also contemplated. FIG. 9 shows an illustrative network environment 900 for use in the methods and systems described herein. In brief overview, referring now to FIG. 9, a block diagram of an illustrative cloud computing environment 900 is shown and described. The cloud computing environment 900 may include one or more resource providers 902a, 902b, 902c (collectively, 902). Each resource provider 902 may include computing resources. In some implementations, computing resources may include any hardware and/or software used to process data. For example, computing resources may include hardware and/or software capable of executing algorithms, computer programs, and/or computer applications. In some implementations, illustrative computing resources may include application servers and/or databases with storage and retrieval capabilities. Each resource provider 902 may be connected to any other resource provider 902 in the cloud computing environment 900. In some implementations, the resource providers 902 may be connected over a computer network 908. Each resource provider 902 may be connected to one or more computing device 904a, 904b, 904c (collectively, 904), over the computer network 908.

The cloud computing environment 900 may include a resource manager 906. The resource manager 906 may be connected to the resource providers 902 and the computing devices 904 over the computer network 908. In some implementations, the resource manager 906 may facilitate the provision of computing resources by one or more resource providers 902 to one or more computing devices 904. The resource manager 906 may receive a request for a computing resource from a particular computing device 904. The resource manager 906 may identify one or more resource providers 902 capable of providing the computing resource requested by the computing device 904. The resource manager 906 may select a resource provider 902 to provide the computing resource. The resource manager 906 may facilitate a connection between the resource provider 902 and a particular computing device 904. In some implementations, the resource manager 906 may establish a connection between a particular resource provider 902 and a particular computing device 904. In some implementations, the resource manager 906 may redirect a particular computing device 904 to a particular resource provider 902 with the requested computing resource.

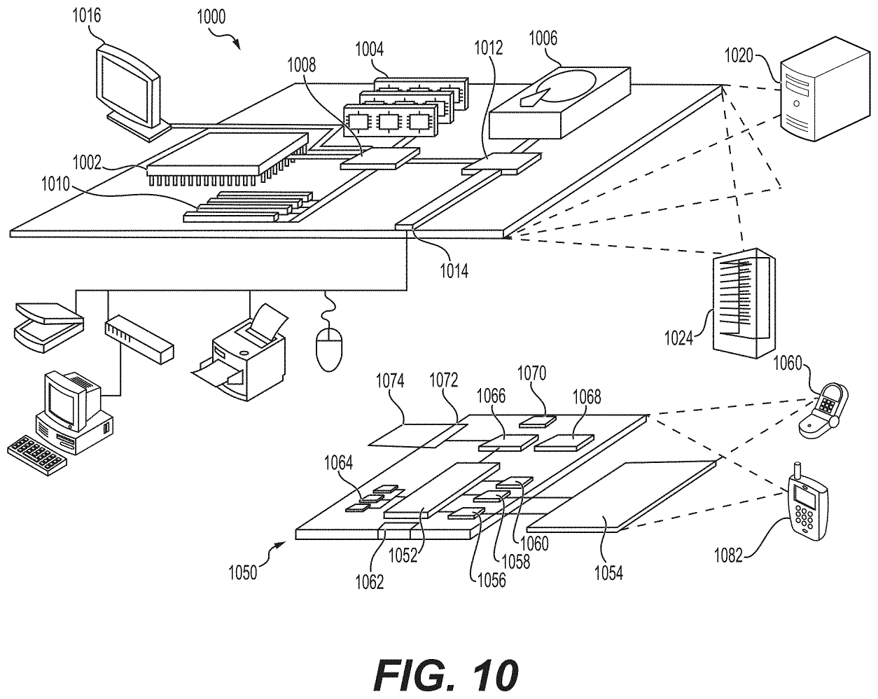

FIG. 10 shows an example of a computing device 1000 and a mobile computing device 1050 that can be used in the methods and systems described in this disclosure. The computing device 1000 is intended to represent various forms of digital computers, such as laptops, desktops, workstations, personal digital assistants, servers, blade servers, mainframes, and other appropriate computers. The mobile computing device 1050 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1000 includes a processor 1002, a memory 1004, a storage device 1006, a high-speed interface 1008 connecting to the memory 1004 and multiple high-speed expansion ports 1010, and a low-speed interface 1012 connecting to a low-speed expansion port 1014 and the storage device 1006. Each of the processor 1002, the memory 1004, the storage device 1006, the high-speed interface 1008, the high-speed expansion ports 1010, and the low-speed interface 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as a display 1016 coupled to the high-speed interface 1008. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system). Also, multiple computing devices may be connected, with each device providing portions of the necessary operations (e.g., as a server bank, a group of blade servers, or a multi-processor system). Thus, as the term is used herein, where a plurality of functions are described as being performed by “a processor”, this encompasses embodiments wherein the plurality of functions are performed by any number of processors (e.g., one or more processors) of any number of computing devices (e.g., one or more computing devices). Furthermore, where a function is described as being performed by “a processor”, this encompasses embodiments wherein the function is performed by any number of processors (e.g., one or more processors) of any number of computing devices (e.g., one or more computing devices) (e.g., in a distributed computing system).

The memory 1004 stores information within the computing device 1000. In some implementations, the memory 1004 is a volatile memory unit or units. In some implementations, the memory 1004 is a non-volatile memory unit or units. The memory 1004 may also be another form of computer-readable medium, such as a magnetic or optical disk.

The storage device 1006 is capable of providing mass storage for the computing device 1000. In some implementations, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1002), perform one or more methods, such as those described above. The instructions can also be stored by one or more storage devices such as computer- or machine-readable mediums (for example, the memory 1004, the storage device 1006, or memory on the processor 1002).

The high-speed interface 1008 manages bandwidth-intensive operations for the computing device 1000, while the low-speed interface 1012 manages lower bandwidth-intensive operations. Such allocation of functions is an example only. In some implementations, the high-speed interface 1008 is coupled to the memory 1004, the display 1016 (e.g., through a graphics processor or accelerator), and to the high-speed expansion ports 1010, which may accept various expansion cards (not shown). In the implementation, the low-speed interface 1012 is coupled to the storage device 1006 and the low-speed expansion port 1014. The low-speed expansion port 1014, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. In addition, it may be implemented in a personal computer such as a laptop computer 1022. It may also be implemented as part of a rack server system 1024. Alternatively, components from the computing device 1000 may be combined with other components in a mobile device (not shown), such as a mobile computing device 1050. Each of such devices may contain one or more of the computing device 1000 and the mobile computing device 1050, and an entire system may be made up of multiple computing devices communicating with each other.

The mobile computing device 1050 includes a processor 1052, a memory 1064, an input/output device such as a display 1054, a communication interface 1066, and a transceiver 1068, among other components. The mobile computing device 1050 may also be provided with a storage device, such as a micro-drive or other device, to provide additional storage. Each of the processor 1052, the memory 1064, the display 1054, the communication interface 1066, and the transceiver 1068, are interconnected using various buses, and several of the components may be mounted on a common motherboard or in other manners as appropriate.

The processor 1052 can execute instructions within the mobile computing device 1050, including instructions stored in the memory 1064. The processor 1052 may be implemented as a chipset of chips that include separate and multiple analog and digital processors. The processor 1052 may provide, for example, for coordination of the other components of the mobile computing device 1050, such as control of user interfaces, applications run by the mobile computing device 1050, and wireless communication by the mobile computing device 1050.

The processor 1052 may communicate with a user through a control interface 1058 and a display interface 1056 coupled to the display 1054. The display 1054 may be, for example, a TFT (Thin-Film-Transistor Liquid Crystal Display) display or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may provide communication with the processor 1052, so as to enable near area communication of the mobile computing device 1050 with other devices. The external interface 1062 may provide, for example, for wired communication in some implementations, or for wireless communication in other implementations, and multiple interfaces may also be used.

The memory 1064 stores information within the mobile computing device 1050. The memory 1064 can be implemented as one or more of a computer-readable medium or media, a volatile memory unit or units, or a non-volatile memory unit or units. An expansion memory 1074 may also be provided and connected to the mobile computing device 1050 through an expansion interface 1072, which may include, for example, a SIMM (Single In Line Memory Module) card interface. The expansion memory 1074 may provide extra storage space for the mobile computing device 1050, or may also store applications or other information for the mobile computing device 1050. Specifically, the expansion memory 1074 may include instructions to carry out or supplement the processes described above, and may include secure information also. Thus, for example, the expansion memory 1074 may be provided as a security module for the mobile computing device 1050, and may be programmed with instructions that permit secure use of the mobile computing device 1050. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 1052), perform one or more methods, such as those described above. The instructions can also be stored by one or more storage devices, such as one or more computer- or machine-readable mediums (for example, the memory 1064, the expansion memory 1074, or memory on the processor 1052). In some implementations, the instructions can be received in a propagated signal, for example, over the transceiver 1068 or the external interface 1062.

The mobile computing device 1050 may communicate wirelessly through the communication interface 1066, which may include digital signal processing circuitry where necessary. The communication interface 1066 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1068 using a radio-frequency. In addition, short-range communication may occur, such as using a Bluetooth®, Wi-Fi™, or other such transceiver (not shown). In addition, a GPS (Global Positioning System) receiver module 1070 may provide additional navigation- and location-related wireless data to the mobile computing device 1050, which may be used as appropriate by applications running on the mobile computing device 1050.

The mobile computing device 1050 may also communicate audibly using an audio codec 1060, which may receive spoken information from a user and convert it to usable digital information. The audio codec 1060 may likewise generate audible sound for a user, such as through a speaker, e.g., in a handset of the mobile computing device 1050. Such sound may include sound from voice telephone calls, may include recorded sound (e.g., voice messages, music files, etc.) and may also include sound generated by applications operating on the mobile computing device 1050.

The mobile computing device 1050 may be implemented in a number of different forms, as shown in the figure. For example, it may be implemented as a cellular telephone 1080. It may also be implemented as part of a smart-phone 1082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

What is claimed is:

1. A method of providing live sample monitoring information to a user, the method comprising:
generating, by a processor of a computing device, in real time, one or more images of a sample based, at least in part, on sample light received from micro optical elements in a micro optical element array without scanning the array or the sample.

2. The method of claim 1, wherein, for each of the one or more images, neighboring pixels in the image represent portions of the sample light received from ones of the micro optical elements for different locations in the sample, the different locations separated by a characteristic distance for the array.

3. The method of claim 1, wherein the array remains in a fixed position during the generating.

4. The method of claim 1, wherein the sample is unperturbed during the generating.

5. The method of claim 1, wherein image pixels of each of the one or more images correspond to sample light (e.g., fluorescence) received from micro optical elements in the array.

6. (canceled)

7. The method of claim 2, wherein each of the image pixels corresponds to sample light received from one of the micro optical elements in the array.

8. The method of claim 1, comprising determining whether a bubble is represented in one or more of the one or more images.

9-10. (canceled)

11. The method of claim 8, comprising adjusting the sample in response to determining that no bubble is represented in the one or more of the one or more images.

12. The method of claim 1, comprising determining whether the sample has sufficiently large area that is in focus in one or more of the one or more images.

13-14. (canceled)

15. The method of claim 12, comprising adjusting the sample in response determining whether the sample has the sufficiently large area that is in focus in the one or more of the one or more images.

16. The method of claim 1, comprising adjusting the sample during the generating in response to the one or more images.

17. The method of claim 1, wherein the sample is accessible to a user during the generating.

18. The method of claim 1, comprising initiating imaging of the sample based on the one or more images, wherein imaging the sample comprises scanning the micro optical element array.

19. The method of claim 18, comprising initiating the imaging automatically by the processor in response to determining one or more of the one or more images are sufficient to indicate the sample has stabilized.

20. (canceled)

21. The method of claim 20, wherein determining the one or more of the one or more images are sufficient to indicate the sample has stabilized comprises determining, by the processor, that no bubble is represented in the one or more of the one or more images.

22. The method of claim 20, wherein determining the one or more of the one or more images are sufficient to indicate the sample has stabilized comprises determining, by the processor, that the sample has sufficiently large area that is in focus in the one or more of the one or more images.

23-43. (canceled)

44. The method of claim 1, comprising displaying, by the processor, the one or more images as the one or more images are generated.

45. The method of claim 44, comprising repeatedly collecting the sample light received from the micro optical elements over a period of time such that the one or more images are generated and displayed at a rate of at least 4 images per second.

46. The method of claim 1, wherein the generating is performed in real time such that the generating are only delayed by time required for processing.

47. The method of claim 1, wherein image pixels in each of the one or more images correspond to sample light received from the micro optical elements over a period of time of no more than 0.25 s.

48. The method of claim 47, wherein the period of time is no more than 0.005 s.

49-58. (canceled)
